(19) United States
(12) Patent Application Publication
(10) Pub. No.: US 2026/0124865 A1
(43) Pub. Date: May 7, 2026

(54) LOCKING PIN COVER APPARATUS

(71) Applicant: B & W Custom Truck Beds, Inc., Humboldt, KS (US)

(72) Inventors: Travis M. McCall, Humboldt, KS (US); Austin Rasmussen, Toronto, KS (US)

(73) Assignee: B & W Custom Truck Beds, Inc., Humboldt, KS (US)

(21) Appl. No.: 19/377,878

(22) Filed: Nov. 3, 2025

Related U.S. Application Data
(60) Provisional application No. 63/716,121, filed on Nov. 4, 2024.

(51) Int. Cl. B60D 1/60; B60D 1/06; B60D 1/07; B60D 1/46

(52) U.S. Cl. CPC B60D 1/60; B60D 1/06; B60D 1/07; B60D 1/46

(57) ABSTRACT

A locking pin cover assembly for preventing theft of hitch pins. The locking pin cover assembly is used with a hitch assembly and includes a hitch pin cover structure and a lock and may include a retaining clip. The hitch pin cover structure is suitable to fit against the hitch assembly and is extendable in covering relationship over the ends of the hitch pins. The hitch pin cover structure includes features to abuttingly receive the ends of the hitch pins. The lock is advanceable between a locked position wherein the hitch pin cover structure is fixedly secured to the hitch assembly to obstruct access to the hitch pins and an unlocked position wherein the hitch pin cover structure is removable from the hitch assembly to expose the hitch pins.

### CROSS REFERENCE TO RELATED APPLICATION

This application claims the benefit of U.S. Provisional Patent Application No. 63/716,121 filed November 4, 2024, the disclosure of which is hereby incorporated herein in its entirety by reference.

### FIELD OF THE INVENTION

This invention relates to locks for trailer hitch components, and in particular to a lock that covers trailer hitch pins.

### BACKGROUND

Trailer hitch pins are commonly used to secure trailers to towing vehicles, providing removable connection points that enable attachment and detachment of the trailer to and from the towing vehicle. Trailer hitch pins are often exposed for easy accessibility, which is convenient to genuine users but also poses security risks. For example, a thief can quickly remove exposed trailer hitch pins to detach the trailer from the towing vehicle before stealing the trailer. Even when security measures such as alarm systems, chains, and other wheel locks are used to prevent theft of the trailer itself, thieves often steal the exposed trailer hitch pins resulting in inconvenience and frustration to genuine users.

Various trailer hitch pin locks have been developed to address this issue. Known trailer hitch pin locks include padlock-style or U-shaped devices that fit around the trailer hitch pins to prevent their removal. Trailer hitch pins having lock mechanisms integrated or embedded therein have also been introduced. Such devices are often bulky or prone to rust and can be challenging to use in adverse conditions such as cold or wet weather. Further, many of the known devices lack sufficient security measures, and are easily overcome by bolt cutters or other tools.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a pin cover assembly that is removably and lockably securable to a hitch assembly and prevents theft of hitch pins used therewith.

The pin cover assembly generally comprises a hitch pin cover and a lock. The hitch pin cover fits against a side beam of the hitch assembly and extends in covering relationship over ends of the hitch pins, which are received by features of the hitch pin cover and abut against or extend in closely spaced relation thereto. The lock is received by the hitch pin cover and is selectively engageable with a side beam of the hitch assembly or with a retaining clip configured to hook around the side beam of the hitch assembly. When the pin cover assembly is fixedly secured to the side beam, the features of the hitch pin cover cooperate with the ends of the hitch pins to prevent lateral displacement of the hitch pin cover from the side beam and the lock, or the lock and the retaining clip cooperatively, prevent outward displacement of the hitch pin cover from the side beam.

In one embodiment of the pin cover assembly, the hitch pin cover comprises two covering shells that are oriented outwardly of the hitch pins to prevent removal of the hitch pins from the hitch assembly and engagement structures for receiving the ends of the hitch pins. A generally J-shaped retaining clip includes a shank leg with a slot formed therein and a tip leg spaced apart from the shank leg to form a groove. The shank leg extends through an opening formed in the hitch pin cover and is selectively slidable laterally relative to the hitch pin cover. When the pin cover assembly is secured to the hitch assembly,the retaining clip hooks around the lower face of a side beam of the hitch assembly with the shank leg fitting against an outer face of the side beam and the tip leg fitting against the inner face of the side beam.

The lock is received by the hitch pin cover and includes a keyed lock barrel which extends into an interior space formed within the hitch pin cover and a bolt which extends from the lock barrel through the slot formed in the shank leg of the retaining clip. The lock is advanceable between a locked position wherein flats on the bolt engage with features of the shank leg to fix the position of the retaining clip and an unlocked position wherein the flats on the bolt disengage from features of the shank leg and the retaining clip is slidable into or out of the hitch pin cover.

In use, the lock is advanced to the unlocked position with the flats of the bolt disengaged from the features of the shank leg and the retaining clip is slid downwardly until the bolt reaches an end of the slot. The pin cover assembly is moved toward the hitch assembly until the hitch pin cover fits against the outer face of the side beam and the ends of the hitch pins are received by the engagement structures. The retaining clip is then slid upwardly until it hooks around the side beam, and the lock is advanced from the unlocked position to the locked position such that the flats of the bolt engage with the features of the shank leg. The pin cover assembly is thus lockably secured to the side beam, with the hitch pin cover oriented in covering relationship with the ends of the hitch pins and obstructing access to the hitch pins. To remove the pin cover assembly from the hitch assembly, the lock is advanced from the locked position to the unlocked position, and the retaining clip is slid downwardly until the bolt reaches the end of the slot. The pin cover assembly can then be pulled outwardly from the side beam to allow access to the hitch pins for adjustment of the hitch assembly.

In an alternative embodiment of the pin cover assembly, the hitch pin cover is generally triangular and includes recesses formed therein for receiving the ends of the hitch pins. A generally S-shaped retaining clip includes first and second shank legs that are selectively extendable into a shank groove formed in the hitch pin cover, the first and second shank legs having first and second bolt holes formed respectively therein. The retaining clip further includes a hook leg and first and second cross-arms which cooperate to connect the first and second shank legs such that the first and second shank legs are spaced apart from the hook leg to form first and second slots. When the pin cover assembly is secured to the hitch assembly, the retaining clip hooks around the upper face of a side beam of the hitch assembly with the first or second shank leg fitting against an outer face of the side beam and the hook leg fitting against the inner face of the side beam.

The lock is received by the hitch pin cover and includes a keyed lock barrel that extends into a chamber formed in the hitch pin cover and a bolt that is extendable out of or retractable into the lock barrel. The lock is advanceable between a locked position wherein the bolt extends through the first or second bolt hole to fix the hitch pin cover to the retaining clip and an unlocked position wherein the bolt retracts out of the first or second bolt hole and the hitch pin cover may be pulled away from the retaining clip.

In use, the lock is advanced to the unlocked position with the bolt retracted into the lock barrel and the retaining clip is pulled out of the shank groove until the hitch pin cover and the retaining clip are spatially separated. The retaining clip is moved downwardly toward the hitch assembly until it hooks around the side beam, and the hitch pin cover is moved toward the hitch assembly until it fits against the outer face of the side beam and the first or second shank leg extends into the shank groove. The lock is then advanced from the unlocked position to the locked position such that the bolt extends through the first or second bolt hole. The pin cover assembly is thus lockably secured to the side beam, with the hitch pin cover oriented in covering relationship with the ends of the hitch pins and obstructing access to the hitch pins. To remove the pin cover assembly from the hitch assembly, the lock is advanced from the locked position to the unlocked position. The hitch pin cover can then be pulled outwardly from the side beam to allow access to the hitch pins for adjustment of the hitch assembly.

A second alternative embodiment of the pin cover assembly is similar to the first alternative embodiment in that it includes a generally triangular hitch pin cover and has recesses formed therein for receiving the ends of the hitch pins. The lock of the second alternative embodiment is received by the hitch pin cover and comprises a lock barrel that extends into a chamber formed in the hitch pin cover. The lock in this embodiment, however, includes a shaft that extends from the lock barrel and is equipped with one or more ball detents that are extendable out of or retractable into the shaft. The lock is advanceable between a locked position wherein the ball detents extend out of the shaft to secure the pin cover assembly to a side beam of the hitch assembly and an unlocked position wherein the ball detents retract into the shaft and the pin cover assembly may be pulled away from the side beam.

In use, the lock is advanced to the unlocked position with the detents retracted into the shaft and the pin cover assembly is moved toward the hitch assembly until the shaft passes through a shaft hole formed in the side beam and the hitch pin cover fits against the outer face of the side beam. The lock is then advanced from the unlocked position to the locked position such that the ball detents extend out of the shaft. The pin cover assembly is thus lockably secured to the side beam, with the hitch pin cover oriented in covering relationship with the ends of the hitch pins and obstructing access to the hitch pins. To remove the pin cover assembly from the hitch assembly, the lock is advanced from the locked position to the unlocked position and the pin cover assembly is pulled outwardly from the side beam to allow access to the hitch pins for adjustment of the hitch assembly.

A third alternative embodiment of the pin cover assembly is similar to the first and second alternative embodiments in that it includes a hitch pin cover that has recesses formed therein for receiving the ends of the hitch pins. The hitch pin cover in this embodiment, however, is generally oblong and extends only over those hitch pins extending through holes formed in a drawbar of the hitch assembly. The lock of the third alternative embodiment comprises a keyed lock barrel that extends through an opening formed in the hitch pin cover and is equipped with a latch that is extendable out of or retractable into the lock barrel. The lock is advanceable between a locked position wherein the latch extends out of the lock barrel to secure the pin cover assembly to a side beam of the hitch assembly and an unlocked position wherein the latch retracts into the lock barrel and the pin cover assembly may be pulled away from the side beam.

In use, the lock is advanced to the unlocked position with the latch retracted into the lock barrel and the pin cover assembly is moved toward the hitch assembly until the lock barrel passes through a lock hole formed in the side beam and the hitch pin cover fits against the outer face of the side beam. The lock is then advanced from the unlocked position to the locked position such that the latch extends out of the lock barrel. The pin cover assembly is thus lockably secured to the side beam, with the hitch pin cover oriented in covering relationship with the ends of the hitch pins and obstructing access to the hitch pins. To remove the pin cover assembly from the hitch assembly, the lock is advanced from the locked position to the unlocked position and the pin cover assembly is pulled outwardly from the side beam to allow access to the hitch pins for adjustment of the hitch assembly.

### DESCRIPTION OF THE DRAWINGS

Illustrative embodiments of the invention are described in detail below with reference to the attached drawing figures, and wherein:

FIG. 1 is a perspective view of a pin cover assembly in accordance with an embodiment of the invention secured to a hitch assembly with a lock in a locked position, viewed from below and to the right;

FIG. 2 is a perspective view of the assembly of FIG. 1 secured to a hitch assembly with a lock in a locked position, viewed from below and to the right and depicted with a hitch pin cover removed for clarity;

FIG. 3 is a perspective view of the assembly of FIG. 1, viewed from above and to the left and depicted with a hitch assembly removed for clarity;

FIG. 4 is a left side elevational view of the assembly of FIG. 1, depicted with hitch pins shown, and with a hitch assembly, retaining clip, and lock removed for clarity;

FIG. 5 is a perspective view of the assembly of FIG. 1 secured to a hitch assembly with a lock in an unlocked position, viewed from below and to the right and depicted with a hitch pin cover removed for clarity;

FIG. 6 is a perspective view of the assembly of FIG. 1 secured to a hitch assembly with a lock in an unlocked position, viewed from below and to the right;

FIG. 7 is a perspective view of the assembly of FIG. 1 exploded away from a hitch assembly, viewed from below and to the right;

FIG. 8 is a perspective view of an alternative embodiment of the pin cover assembly secured to a hitch assembly with a lock in a locked position, viewed from above and to the right;

FIG. 9 is a perspective view of the assembly of FIG. 8 secured to a hitch assembly with a lock in a locked position, viewed from above and to the right and depicted with a hitch pin cover removed for clarity;

FIG. 10 is a perspective view of the assembly of FIG. 8, viewed from above and to the left and depicted with a hitch assembly removed for clarity;

FIG. 11 is a left side elevational view of the assembly of FIG. 8, depicted with the hitch pins shown, and with a hitch assembly, retaining clip, and lock removed for clarity;

FIG. 12 is a perspective view of the assembly of FIG. 8 with a retaining clip partially exploded away from a hitch assembly and a lock in an unlocked position, viewed from above and to the right and depicted with a hitch pin cover removed for clarity;

FIG. 13 is a perspective view of the assembly of FIG. 8 with a hitch pin cover and a lock exploded away from a hitch assembly, viewed from above and to the right;

FIG. 14 is a perspective view of the assembly of FIG. 8 exploded away from a hitch assembly, viewed from above and to the right;

FIG. 15 is a perspective view of a second alternative embodiment of the locking pin cover secured to a hitch assembly, viewed from above and to the right;

FIG. 16 is a perspective view of the assembly of FIG. 15 secured to a hitch assembly, viewed from above and to the right and depicted with a hitch pin cover removed for clarity;

FIG. 17 is a top plan view of the assembly of FIG. 15 secured to a hitch assembly and depicted with a hitch pin cover removed for clarity;

FIG. 18 is a perspective view of the assembly of FIG. 15, viewed from above and to the left and depicted with a lock removed for clarity;

FIG. 19 is a left side elevational view of the assembly of FIG. 15, depicted with the hitch pins shown for clarity;

FIG. 20 is a perspective view of the assembly of FIG. 15 exploded away from a hitch assembly, viewed from above and to the right;

FIG. 21 is a perspective view of a third alternative embodiment of the pin cover assembly secured to a hitch assembly, viewed from above and to the right;

FIG. 22 is a perspective view of the assembly of FIG. 21 with a lock in a locked position, viewed from above and to the right;

FIG. 23 is a perspective view of the assembly of FIG. 21 with a lock in a locked position, viewed from above and to the left;

FIG. 24 is a perspective view of the assembly of FIG. 21 exploded away from a hitch assembly, viewed from above and to the right.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

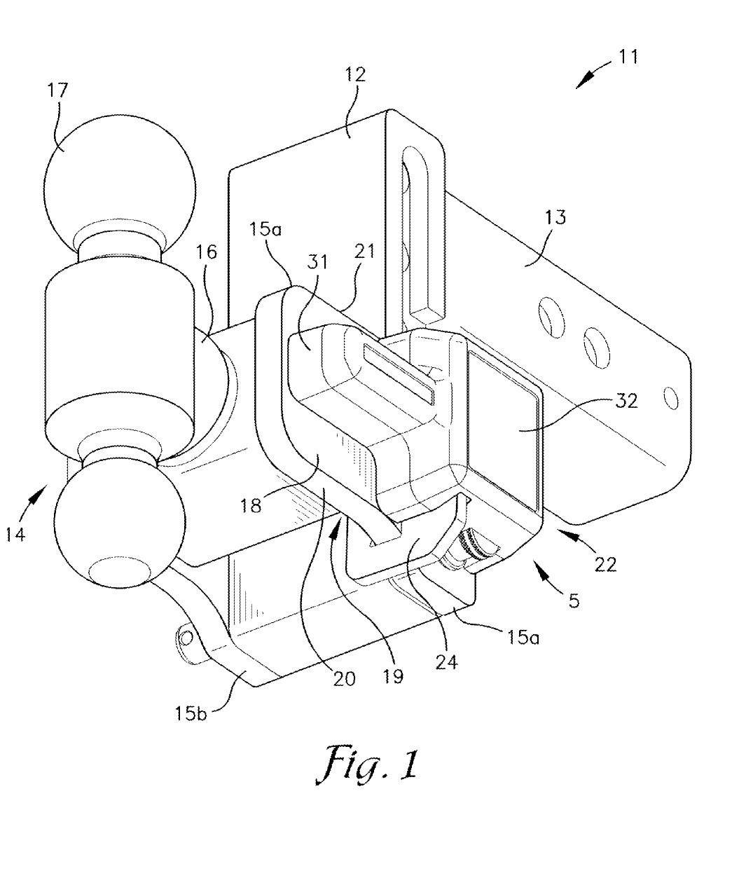

As used herein, directional references may be used with reference to the orientation of the vehicle to which a hitch assembly equipped with the inventive locking pin cover assembly or apparatus is configured to be secured, with the hitch assembly being in a use position in which a coupler of a trailer is engageable with the hitch assembly. With reference to FIG. 1, the words “front” or “forward” refer to the right of the page and the words “rear” or “rearward” refer to the left of the page. Similarly, the words “upper” or “upwardly” refer to the top of the page and the words “lower” or “downwardly” refer to the bottom of the page. The words “inwardly” and “outwardly” will refer to directions toward and away from, respectively, the geometric center of the embodiment being described and designated parts thereof. Said terminology will include the words specifically mentioned, derivatives thereof and words of a similar import.

With reference to the drawings in more detail, a locking, hitch pin cover assembly or pin cover assembly 5 prevents theft of hitch pins 10a and 10b used with a hitch assembly 11 for connecting a trailer (not shown) to a towing vehicle (not shown). The pin cover assembly 5 is particularly well-adapted for use with ball-type hitch assemblies that may be stowable, such as the hitch assembly disclosed in U.S. Patent No. 6,974,148 (the “’148 Patent”) assigned to B&W Custom Truck Beds, Inc. of Humboldt, Kansas. As shown in FIG. 1, the hitch assembly 11 includes a drawbar or pin block 12 which is connected to a shank 13, and a hitch ball mount 14 comprising a pair of side beams 15a and 15b and a hitch ball assembly 16. The hitch ball mount 14 is adjustably securable to the drawbar 12 by one or more hitch pins 10a which extend through holes or features formed in the side beams 15a and 15b and selected ones of a plurality of holes or features formed in the drawbar 12. The holes or features formed in the side beams 15a and 15b are alignable with holes or features formed in the drawbar 12. The hitch ball assembly 16 is supported by the hitch ball mount 14 and includes multiple outwardly projecting hitch balls 17. The rotational position of the hitch ball assembly 16 is fixed by a hitch pin 10b selectively inserted through holes or features formed in the side beams 15a and 15b and one of a pair of holes or features formed in the hitch ball assembly 16. The holes or features formed in the hitch ball assembly 16 are alignable with the holes or features formed in the side beams 15a and 15b as the rotational position of the hitch ball assembly 16 is adjusted. Embodiments of the locking, hitch pin cover assembly 5 shown and described herein are discussed as being engageable with or secured to the side beam 15a and an outer face 18, inner face 19, lower face 20, and upper face 21 thereof, but it is understood that the pin cover assembly may alternatively be engaged with or secured to the side beam 15b and like faces thereof.

The pin cover assembly 5 is removably and lockably securable to the side beam 15a and comprises a hitch pin cover structure 22, a lock 23, and a retaining clip 24. The hitch pin cover structure or cover which may also be referred to as a shell member 22 fits against the outer face 18 of the side beam 15a and is oriented outwardly of the cylindrical heads or ends 25 of the hitch pins 10a, 10b in covering relationship therewith for obstructing access to the hitch pins 10a, 10b and impeding removal of the hitch pins 10a, 10b from the hitch assembly 11. The lock 23 comprises a keyed lock barrel 26 that extends into the hitch pin cover structure 22 and a bolt 27 that extends axially from the keyed lock barrel 26. In the embodiment shown in FIGS. 1-7, the retaining clip 24 is hook shaped and comprises a shank leg 28 with a slot 29 formed therein and a tip leg or hook leg 30 spaced apart from the shank leg 28 by a groove or throat 97. The retaining clip 24 is matingly engageable with the side beam 15a and the shank leg 28 is slidable into and out of the hitch pin cover structure 22. When the pin cover assembly 5 is secured to the side beam 15a,the retaining clip 24 hooks around the lower face 20 of the side beam 15a and the shank leg 28 and tip leg 30 are engagingly positioned against the outer face 18 and inner face 19 of the side beam 15a, respectively. The lock 23 is advanceable between a first or locked position wherein the bolt 27 engages with features of the shank leg 28 to fix the position of the retaining clip 24 relative to the hitch pin cover 22 and the lock 23 and a second or unlocked position wherein the shank leg 28 is slidable relative to the bolt 27 such that the retaining clip 24 is movable relative to the hitch pin cover structure 22 and the lock 23.

The hitch pin cover 22 comprises first and second concave portions or covering shells 31 and 32 which are integrally formed together and may also be referred to as forward and rearward concave portions or covering shells 31 and 32 corresponding to the relative sections of the outer face 18 of the side beam 15a covered by the covering shells 31 and 32 when the assembly 5 is secured to the side beam 15a. When the assembly 5 is secured to the side beam 15a, the ends 25 of the hitch pins 10a extend into an interior space 33 defined by the first covering shell 31 and the end 25 of the hitch pin 10b extends into an interior space 34 defined by the second covering shell 32. The ends 25 of the hitch pins 10a and 10b are shown and described herein as generally cylindrical structures, but it is understood that the ends 25 may alternatively comprise pull-rings, handles, knobs, and other like structures which are graspable to remove the hitch pins 10a and 10b from the hitch assembly 11.

In the embodiment shown in FIGS. 1-7, the first and second covering shells 31 and 32 are oriented along a common central longitudinal axis and are generally polygonal with the first covering shell 31 having a greater height than the second covering shell 32. The second covering shell 32 extends rearwardly from the first covering shell 31 sufficiently to extend in covering relationship over the end 25 of the hitch pin 10b when the hitch pin 10b extends through either of the pair of holes formed in the hitch ball assembly 16 and the aligned holes formed in the side beams 15a and 15b. It is foreseen that the hitch pin cover 22 may comprise a single covering shell or more than two covering shells without departing from the scope of embodiments of the invention described herein. It is further understood that the hitch pin cover structure 22 or the first and second covering shells 31 and 32 may comprise geometries other than those shown; for example, the hitch pin cover 22 may be generally triangular or elliptical.

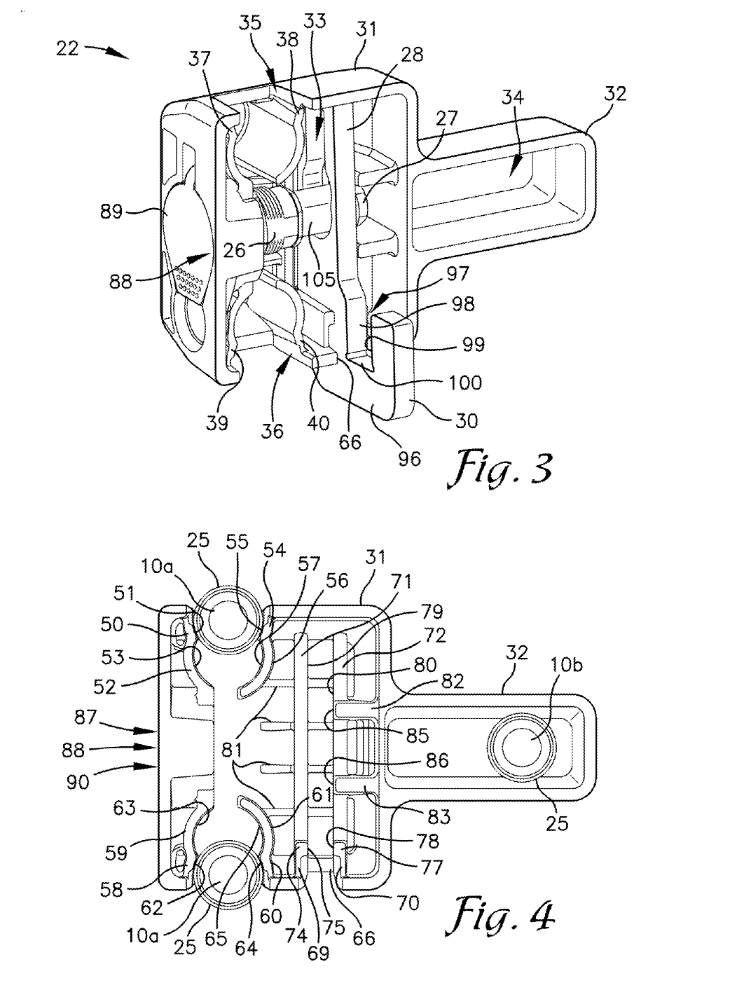

Referring now to FIGS. 3 and 4, upper and lower pin openings 35 and 36 are formed in upper and lower walls of the forward covering shell 31. The upper and lower pin openings 35 and 36 extend outwardly from inner edges of upper and lower walls of the forward covering shell 31. The upper pin opening 35 is sized sufficiently for an approximately semi-cylindrical portion of the end 25 of the upwardly located hitch pin 10a to protrude therethrough and the lower pin opening 36 is similarly sized sufficiently for an approximately semi-cylindrical portion of the end 25 of the downwardly located hitch pin 10b to protrude therethrough. It is foreseen that other cross-sectional profiles of the ends 25 of the hitch pins 10a may protrude through the upper and lower pin openings 35 and 36 with the forward covering shell 31 extending in covering relationship over each hitch pin 10a.

An upper pair of pin engagement structures 37 and 38 and a lower pair of pin engagement structures 39 and 40, which may also be referred to as the first and second upper pin engagement structures 37 and 38 and the first and second lower pin engagement structures 39 and 40, project inwardly from the forward covering shell 31 into the interior space 33. The upper pair of pin engagement structures 37 and 38 are contoured to receive the end 25 of the upwardly located hitch pin 10a and the lower pair of pin engagement structures 39 and 40 are similarly contoured to receive the end 25 of the downwardly located hitch pin 10a such that the upper pin engagement structures 37 and 38 may abut against or extend in closely spaced relation to the end 25 of the upwardly located hitch pin 10a and the lower pin engagement structures 39 and 40 may abut against or extend in closely spaced relation to the end 25 of the downwardly located hitch pin 10a. When the pin cover assembly 5 is secured to the side beam 15a, the ends 25 of the hitch pins 10a fit within the paired pin engagement structures 37, 38 and 39, 40 and the hitch pins 10a cannot be angled, bent, jogged, or otherwise displaced and pulled through the upper or lower pin openings 35 and 36.

The first and second upper pin engagement structures 37 and 38, which are substantially identical in structure except for their mirrored configuration, are disposed in spaced apart relation proximate opposite edges of the upper pin opening 35 formed in the forward covering shell 31. The first upper pin engagement structure 37 comprises a generally arcuate first leg 50 that extends downwardly from the forward covering shell 31 and curves rearwardly to form a first curved surface 51 and a generally arcuate second leg 52 that extends downwardly and curves forwardly from the first leg 50 before curving back rearwardly to form a second curved surface 53. The second upper pin engagement structure 38 comprises a generally arcuate first leg 54 which extends downwardly from the forward covering shell 31 and curves forwardly to form a first curved surface 55 and a generally arcuate second leg 56 which extends downwardly and curves rearwardly from the first leg 54 before curving back forwardly to form a second curved surface 57.

Similar to the upper pair of pin engagement structures 37 and 38, the first and second lower pin engagement structures 39 and 40 are substantially identical in structure except for their mirrored configuration and are disposed in spaced apart relation proximate opposite edges of the lower pin opening 36 formed in the forward covering shell 31. The first lower pin engagement structure 39 comprises generally arcuate first and second legs 58 and 59 and the second lower pin engagement structure 40 comprises generally arcuate first and second legs 60 and 61. The first leg 58 of the first lower pin engagement structure 39 extends upwardly and curves rearwardly from the forward covering shell 31 to form a first curved surface 62 and the second leg 59 extends upwardly and curves forwardly from the first leg 58 before curving back rearwardly to form a second curved surface 63. The first leg 60 of the second lower pin engagement structure 40 extends upwardly and curves forwardly from the forward covering shell 31 to form a first curved surface 64 and the second leg 61 extends upwardly and curves rearwardly from the first leg 60 before curving back forwardly to form a second curved surface 65.

The drawbar 12 and hitch ball mount 14 of the hitch assembly 11 shown and described herein dictate vertical spacing of the hitch pins 10a such that when the pin cover assembly 5 is secured to the side beam 15a,the first curved surfaces 51 and 55 of the upper pin engagement structure 37 and 38 are oriented in proximity to circumferential portions of the end 25 of the upwardly located hitch pin 10a and the first curved surfaces 62 and 64 of the lower pin engagement structures 39 and 40 are oriented in proximity to circumferential portions of the end 25 of the downwardly located hitch pin 10a. But it is understood that the pin cover assembly 5 may be used with differently shaped and sized hitch assemblies, and the upper and lower pairs of pin engagement structures 37, 38 and 39, 40 may receive varyingly spaced apart hitch pins 10a that may be presented by such hitch assemblies. For example, it is foreseen that the pin cover assembly 5 may be used with a hitch assembly wherein the second curved surfaces 53 and 57 of the upper pin engagement structures 37 and 38 are oriented in proximity to circumferential portions of the end 25 of the upwardly located hitch pin 10a and the second curved surfaces 63 and 65 of the lower pin engagement structures 39 and 40 are oriented in proximity to circumferential portions of the end 25 of the downwardly located hitch pin 10a.

With continued reference to FIGS. 3 and 4, a clip opening 66 is formed in the lower wall of the forward covering shell 31. The clip opening 66 extends outwardly from an inner edge of the forward covering shell 31 and is sized sufficient for the shank leg 28 of the retaining clip 24 to pass therethrough as the retaining clip 24 engages with or disengages from the side beam 15a. The clip opening 66 is oriented rearwardly of the lower pin opening 36 in spaced apart relation therefrom, with a portion of the lower wall of the forward covering shell 31 extending between the clip opening 66 and the lower pin opening 36.

A pair of guides or guide posts 69 and 70 and a pair of generally elongate guide ribs 71 and 72 project inwardly from the forward covering shell 31 into the interior space 33 and direct the shank leg 28 as it slides into and out of the interior space 33. The guides 69 and 70, which may also be referred to as the first and second guides 69 and 70, extend upwardly in spaced apart relation from the lower wall of the forward covering shell 31 proximate opposite edges of the clip opening 66 formed therein. The first and second guides 69 and 70 are substantially identical in structure except for their mirrored configuration, with the first guide 69 extending upwardly to a first head 74 on which a first positioning surface 75 is formed and the second guide 70 extending upwardly to a second head 77 on which a second positioning surface 78 is formed.

The guide ribs 71 and 72, which may also be referred to as the first and second guide ribs 71 and 72, extend upwardly in spaced apart relation from the first and second heads 74 and 77 and project inwardly from the forward covering shell 31 into the interior space 33 to a lesser extent than the first and second guides 69 and 70. The first and second guide ribs 71 and 72 are aligned in parallel with one another and are of substantially the same widths as the first and second heads 74 and 77 from which they extend, with a first guide surface 79 formed on the first guide rib 71 and a second guide surface 80 formed on the second guide rib 72. The first guide rib 71 extends in the same plane as the first positioning surface 75 and the second guide rib 72 extends in the same plane as the second positioning surface 78. The shank leg 28 is positionable between the first and second guides 69 and 70 and the first and second guide ribs 71 and 72 such that, when the shank leg 28 extends into the interior space 33 as shown in FIG. 3, longitudinal portions of the shank leg 28 are oriented in proximity with the first and second positioning surfaces 75 and 78 and the first and second guide surfaces 79 and 80.

A plurality of generally elongate support ribs 81 and a pair of support members 82 and 83 further direct the shank leg 28 as it slides into and out of the interior spaces 33. The support ribs 81 are serially disposed along the forward covering shell 31 and extend transversely to the first and second guide ribs 71 and 72 in intersecting relationship therewith. It should be noted that the ribs 81 reinforce the structural integrity of the forward covering shell 31 and the guide ribs 71 and 72, and in an embodiment may extend in intersecting relationship with and reinforce the structural integrity of the upper and lower engagement structures 38 and 40.

As shown in FIG. 4, the support members 82 and 83, which may also be referred to as the upper and lower support members 82 and 83, are oriented in spaced apart relation and project inwardly from the forward covering shell 31 into the interior space 33 with the upper support member 82 forming a first positioning surface 85 and the lower support member 83 forming a second positioning surface 86. The first and second positioning surfaces 85 and 86 extend in the same plane as the second guide surface 80 and, when the shank leg 28 extends into the interior space 33, longitudinal portions of the shank leg 28 are oriented in proximity with the first and second positioning surfaces 85 and 86. It is understood that the upper and lower support members 82 and 83, which extend opposingly from the upper and lower walls of the rearward covering shell 32, reinforce the structural integrity of the forward covering shell 31 and buttress the junction of the forward covering shell 31 and the rearward covering shell 32.

A lock receiving receptacle 87 is formed in the forward wall of the forward covering shell 31 and configured to receive the keyed lock barrel 26 of the lock 23 therein. In the embodiment shown, a lock cap 89 is connected to the lock receptacle 87 by a living hinge. The lock cap 89 is selectively positionable to protect the lock barrel 26 from ingress of debris or moisture or to allow a key (not shown) to enter the lock barrel 26 for selective adjustment of the lock 23 between the unlocked position and the locked position. The lock barrel 26 passes through a passage 90 formed centrally in the receptacle 87 and extends into the interior space 33 on an axis transverse to the shank leg 28 between the upper pair of pin engagement structures 37 and 38 and the lower pair of pin engagement structures 39 and 40.

The bolt 27 of the lock 23 is generally cylindrical with opposed flats 105 (see FIG. 3) formed on opposite sides of the bolt 27. The bolt 27 extends axially from a distal end of the lock barrel 26 into the interior space 33 of the pin lock cover 22 and through the slot 29 formed in the upper portion of the shank leg 28. The slot 29, which is generally sized in correspondence with the bolt 27, extends downwardly along a central longitudinal axis of the shank leg 28 to form a relatively narrow elongate portion 91 before first curving outward toward the sides of the shank leg 28 and just past a pair of stops 92 oriented on opposing edges of the slot 29 and then curving slightly back toward the central longitudinal axis of the shank leg 28 toward a pair of points or tips 93 oriented on opposing edges of the slot 29 to form a first or upper circular portion 94. The slot 29 extends further downward from the upper circular portion 94, curving slightly toward the sides of the shank leg 28 along the points 93 before curving back toward the central longitudinal axis of the shank leg 28 to form a second or lower circular portion 95.

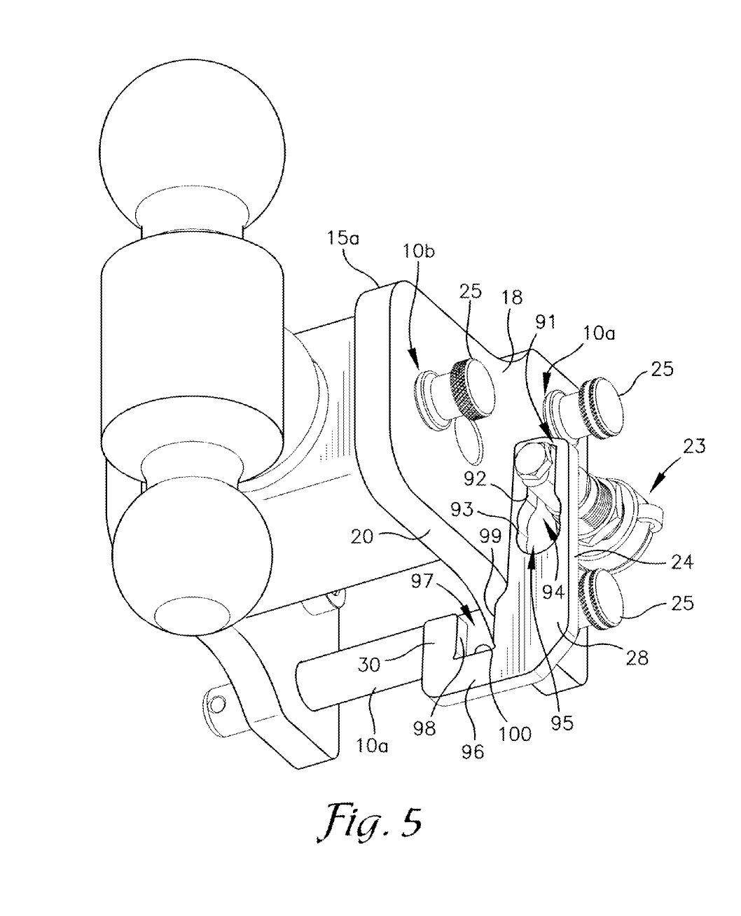

The shank leg 28 of the retaining clip 24 extends downwardly from the slot 29 formed therein and out of the hitch pin cover structure 22. A bend member or cross-arm 96 extends inwardly from a lower end of the shank leg 28 to connect the shank leg 28 and the tip leg 30. The tip leg 30 extends upwardly from the cross-arm 96. As best shown in FIG. 5, the retaining clip 24 is thus generally hook or J-shaped with the throat 97 formed between a first sliding surface 98 of the tip leg 30, a second sliding surface 99 of the shank leg 28, and a positioning surface 100 of the cross-arm 96. The first and second sliding surfaces 98 and 99 fit slidingly against the outer and inner faces 18 and 19 of the side beam 15a and the positioning surface 100 fits snugly against a portion of the lower face 20. The retaining clip 24 thus matingly engages with and can be said to “hook around” the side beam 15a.

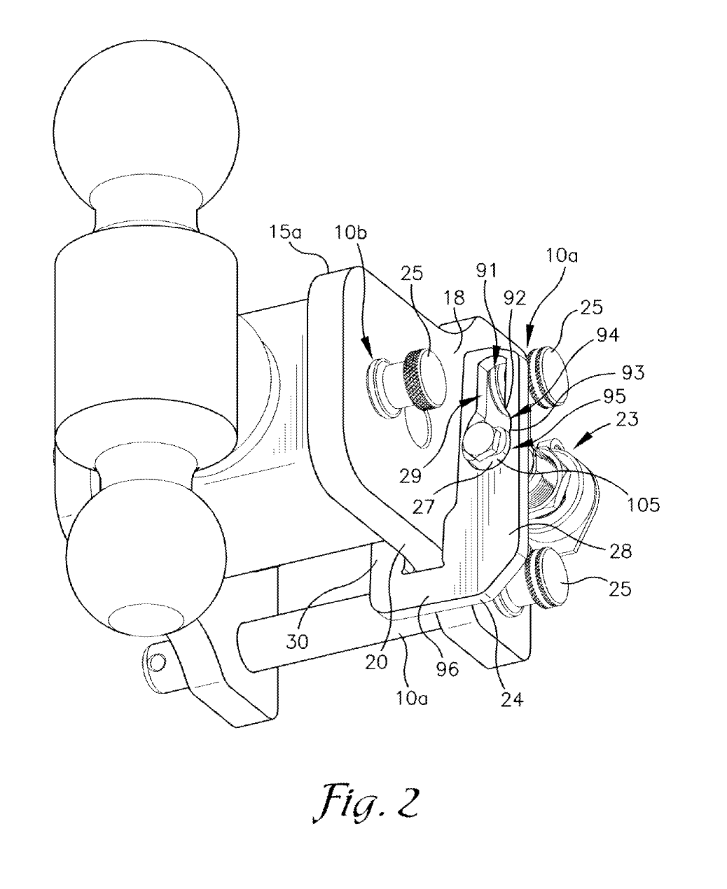

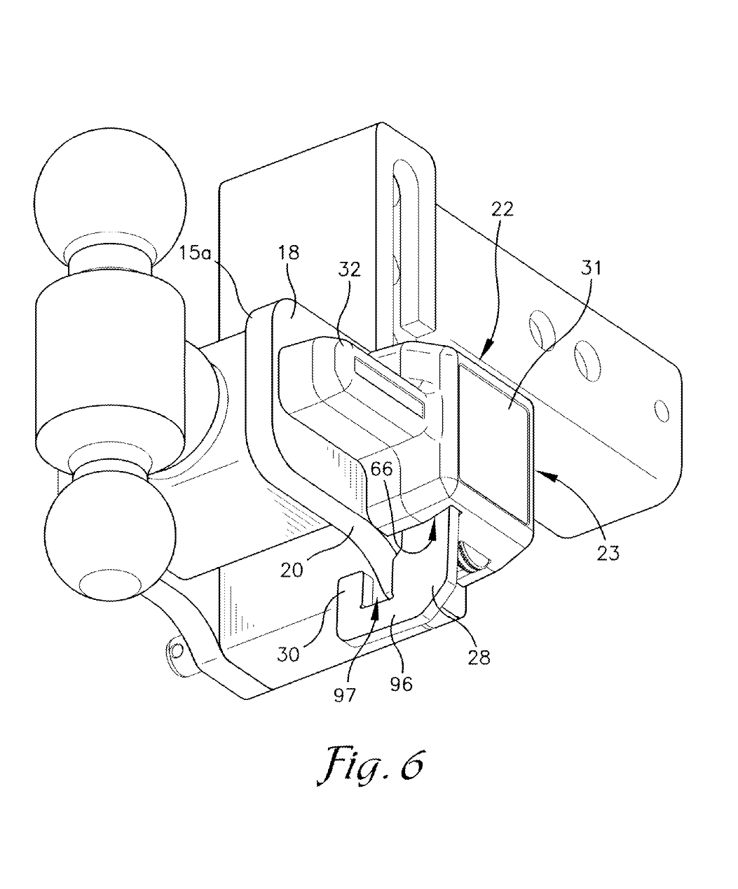

Interaction of the lock 23 and the retaining clip 24 is now described with reference to FIGS. 1, 2, 5, and 6, in which FIGS. 5 and 6 depict the unlocked position of the lock 23 and FIGS. 1 and 2 depict the locked position of the lock 23. Adjustment of the lock 23 to the unlocked position rotates the bolt 27 to a vertical position wherein the flats 105 of the bolt 27 extend generally vertically so that the bolt 27 does not engage with the stops 92 or points 93 of the shank leg 28 as the retaining clip 24 is moved upwardly or downwardly relative to the hitch pin cover structure 22 and the lock 23. Rotational orientation of the bolt 27 so that the flats 105 extend vertically thus enables downward movement of the retaining clip 24 to a position where the bolt 27 extends through the elongate portion 91 of the slot 29 (as shown in FIG. 5) or upward movement of the retaining clip 24 to positions where the bolt 27 extends through the upper circular portion 94 or lower circular portion 95 of the slot 29. It will be appreciated that the slot 29 permits limited movement sliding movement of the retaining clip 24 relative to the hitch pin cover structure 22, with the retaining clip 24 slidable upward and downward until the bolt 27 contacts the ends of the slot 29 when the lock 23 is adjusted to the unlocked position.

With the retaining clip 24 positioned such that the bolt 27 extends through the upper circular portion 94 or lower circular portion 95 of the slot 29, adjustment of the lock mechanism 23 to the locked position rotates the flats of the bolt 27 to a horizontal orientation (as shown in FIG. 2) wherein the rounded sides of the bolt 27 engage with the stops 92 and/or points 93 of the shank leg 28 and the retaining clip 24 is fixed relative to the hitch pin cover structure 22 and the lock 23. Because the lock 23 is advanceable to the locked position when the bolt 27 extends through either the upper or lower circular portion 94 or 95 of the slot 29, the retaining clip 24 can hook around side beams 15a of differing heights and sizes as may be presented when the locking, hitch pin cover assembly 5 is used with differently shaped and sized hitch assemblies. When the retaining clip 24 is hooked around the side beam 15a and the lock 23 is adjusted to the locked position, the assembly 5 is fixedly secured to the side beam 15a, with the retaining clip 24 resisting separation of the hitch pin cover structure 22 from the side beam 15a such that the hitch pin cover structure 22 cannot be pulled or otherwise outwardly displaced therefrom.

Operation of the locking pin cover assembly 5 is now described in accordance with an embodiment of the invention. The hitch assembly 11 is secured to the towing vehicle and the hitch ball mount 14 is adjustably secured to the drawbar 12 at a desired height sufficient for connecting the trailer to the towing vehicle by extending one or more hitch pins 10a through the holes or features formed in the side beams 15a and 15b and the aligned holes or features formed in the drawbar 12. The hitch ball assembly 16 is rotated such that a desired hitch ball 17 extends upwardly for engagement with coupler means of the trailer and the rotational position of the hitch ball assembly 16 is fixed by extending the hitch pin 10b through the holes or features formed in the side beams 15a and 15b and the aligned holes or features formed in the hitch ball assembly 16.

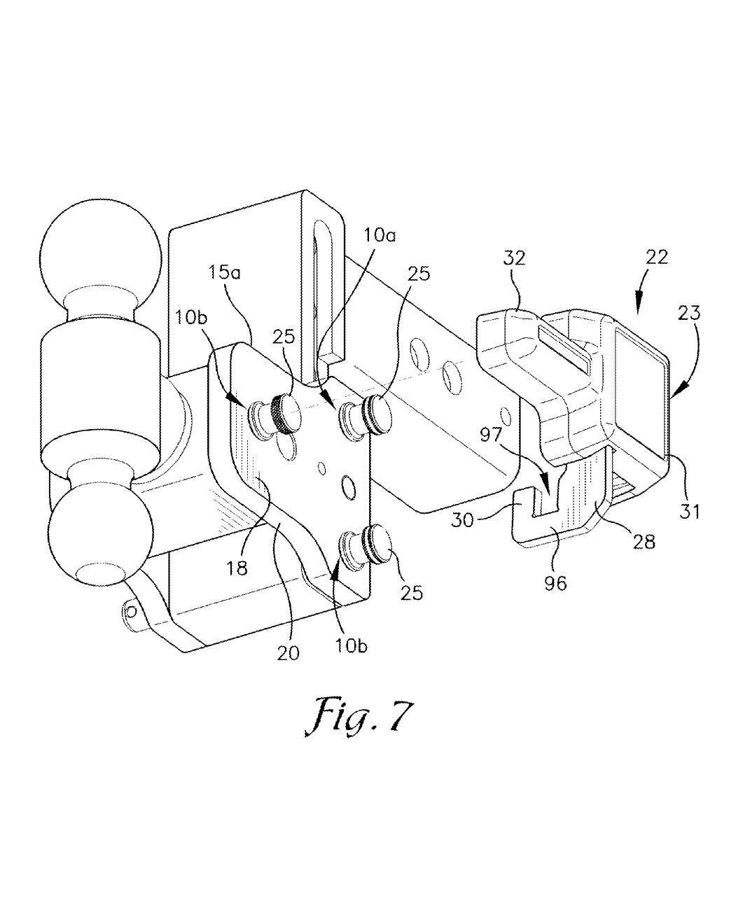

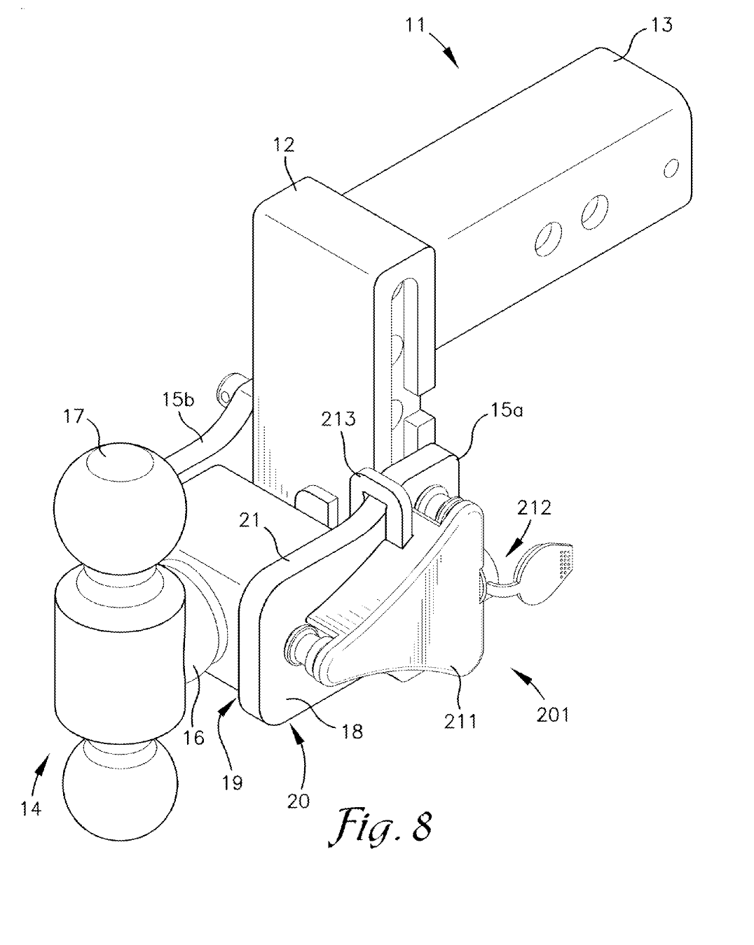

The lock 23 is adjusted to the unlocked position with the bolt 27 rotated to the vertical position, with the flats 105 extending vertically, and the retaining clip 24 is moved downward relative to the hitch pin cover structure 22 and lock 23 until the bolt 27 occupies the elongate portion 91 of the slot 29 and a lower portion of the shank leg 28 passes through the clip opening 66 and extends out of the forward covering shell 31. The pin cover assembly 5 is placed in closely spaced relation form the respective side beam 15a or 15b, in an orientation such as that depicted in FIG. 7, and is moved toward the hitch assembly 11 until the hitch pin cover 22 fits against the outer face 18 of the side beam 15a with the ends 25 of the hitch pins 10a extending into the interior space 33 defined by the forward covering shell 31 and the end 25 of the hitch pin 10b extending into the interior space 34 defined by the rearward covering shell 32. The pin cover assembly 5 is thus positioned with the forward covering shell 31 extending in covering relationship over the ends 25 of the hitch pins 10a and the rearward covering shell 32 extending in covering relationship over the end 25 of the hitch pin 10b as shown in FIG. 6.

The retaining clip 24 is moved upwardly, with the lower portion of the shank leg 28 passing through the clip opening 66 and sliding into the interior space 33 between the first and second guides 69, 70 and the first and second guide ribs 71, 72 until the retaining clip 24 is hooked around the side beam 15a and the vertically oriented bolt 27 extends through the lower circular portion 95 of the slot 29. The lock 23 is rotated from the unlocked position to the locked position and the bolt 27 rotates to the horizontal position with the flats 105 extending horizontally and the circular portion of the bolt 27 engaging the points 93 of the shank leg 28 as shown in FIG. 2. In foreseen embodiments, the side beam 15a may be sized such that when the retaining clip 24 hooks therearound the vertically positioned bolt 27 will extend through the upper circular portion 94 of the slot 29. In such embodiments, when the lock 23 is rotated from the unlocked position to the locked position the bolt 27 rotates to the horizontal position and engages with the points 93 and the stops 92 of the shank leg 28.

The pin lock assembly 5 is thus fixedly secured to the side beam 15a with hitch pin covering structure 22 impeding removal of the hitch pins 10a, 10b from the hitch assembly 11. The paired pin engagement structures 37, 38 and 39, 40 and the respective ends 25 of the hitch pins 10a juxtaposingly received thereby cooperate to prevent upward, downward, rearward, or forward displacement of the hitch pin cover structure 22 from the side beam 15a, and the lock mechanism 23 and retaining clip 24 cooperate to prevent outward displacement of the hitch pin cover structure 22 from the side beam 15a.

To remove the assembly 5 from the side beam 15a as may be desired to adjust the height of the hitch ball mount 14 and/or adjust the rotational position of the hitch ball assembly 16, the lock mechanism 23 is rotated from the locked position to the unlocked position rotating the bolt 27 to the vertical position. The retaining clip 24 is pulled downwardly for disengagement from the side beam 15a until the bolt 27 extends through the elongate portion 91 of the slot 29 and the tip leg 30 is clear of the lower face 20 of the side beam 15a as shown in FIG. 6. The hitch pin cover structure 22 is pulled outwardly from the side beam 15a, exposing the hitch pins 10a and 10b to be removed from the hitch assembly 11 for adjustment of the hitch ball mount 14 and/or hitch ball assembly 16. Upon making the desired adjustments, the pin lock assembly 5 is secured to the side beam 15a as described above to prevent removal of the hitch pins 10a and 10b from the hitch assembly 11.

FIGS. 8-14 depict a first alternative embodiment of the locking, hitch pin cover assembly, which is denominated herein as pin cover assembly 201. Like the pin cover assembly 5, the assembly 201 includes a hitch pin cover structure 211, a lock 212, and a retaining clip 213 and is particularly well-adapted for use with ball-type hitch assemblies that may stowable, such as the hitch assembly disclosed in the ‘148 Patent. The hitch pin assembly 201 is generally used with the same hitch assembly 11 described above and is removably and fixedly securable to the side beam 15a thereof in a similar manner.

The hitch pin cover structure 211 fits against the outer face 18 of the side beam 15a and is oriented outwardly of the heads or ends 25 of the hitch pins 10a, 10b in covering relationship therewith for obstructing access to the hitch pins 10a, 10b and impeding removal of the hitch pins 10a, 10b from the hitch assembly 11. The lock 212 comprises a keyed lock barrel 214 that extends into the hitch pin cover structure 211 and a bolt 215 that is operatively extendable out of or retractable into the keyed lock barrel 214. The retaining clip 213 comprises first and second shank legs 216 and 217 having first and second bolt holes 218 and 219 formed therein and a hook leg 220 that connects the first and second shank legs 216 and 217. The first and second shank legs 216 and 217 are spaced apart from the hook leg 220 by first and second cross-arms 262 and 264 forming first and second slots or throats 265 and 269, respectively, between the hook leg 220 and the first and second shank legs 216 and 217, respectively. The retaining clip 213 is matingly engageable with the side beam 15a by advancing the clip 213 over the side beam 15a so that the side beam 15a advances into a selected slot 265 or 269 of the retaining clip 213. The hitch pin cover structure 211 is then securable over the clip 213 with the outwardly extending shank leg 216 or 217 extending into the hitch pin cover structure 211. When the hitch pin cover assembly 201 is secured to the side beam 15a,the retaining clip 213 hooks around the upper face 21, the selected first or second shank leg 216 or 217 is positioned against the outer face 18, and the hook leg 220 is positioned against the inner face 19. The lock 212 is advanceable between a first or locked position wherein the bolt 215 projects or extends out of the lock barrel 214 and through the first or second bolt hole 218 or 219 to fix the position of the hitch pin cover structure 211 to the retaining clip 213 and a second or unlocked position wherein the bolt 215 is retracted into the lock barrel 214 and the hitch pin cover structure 211 and lock 212 may be pulled away from and separated from the retaining clip 213.

A plurality of recesses are formed in the hitch pin cover structure 211 for receiving the ends 25 of the hitch pins 10a, 10b, including first and second drawbar pin recesses 221 and 222 and first and second hitch ball pin recesses 223 and 224. The end 25 of the upwardly located hitch pin 10a is extendable into the first drawbar pin recess 221, which may also be referred to as the upper drawbar pin recess 221, and the end 25 of the downwardly located hitch pin 10a is extendable into the second drawbar pin recess 222, which may also be referred to as the lower drawbar pin recess 222. The end 25 of the hitch pin 10b is extendable into a selective one of the first and second hitch ball pin recesses 223 and 224 depending on the rotational position of the hitch ball assembly 16. When the hitch pin 10b fixes the hitch ball assembly 16 in the rotational position as shown in FIG. 8, for example, the end 25 thereof extends into the first hitch ball pin recess 223. It is understood that the hitch pin 10b may fix the hitch ball assembly 16 in a rotational position wherein the end 25 thereof extends into the second hitch ball pin recess 224.

In the embodiment shown in FIGS. 8-14, the hitch pin cover structure 211 is a generally triangular structure, but it is foreseen that the hitch pin cover structure 211 may comprise other geometries, such as polygonal or elliptical, and it is further foreseen that the hitch pin cover structure 211 may be a shell-like or substantially hollow structure having one or more interior spaces formed therein.

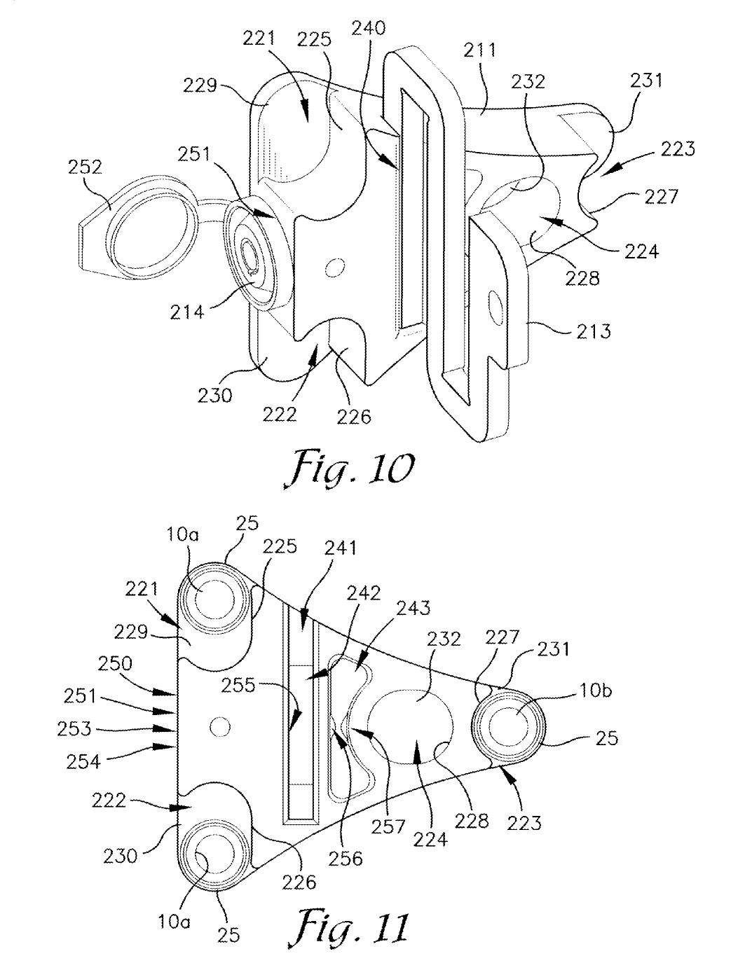

Referring now to FIGS. 10 and 11, the upper drawbar pin recess 221 is defined by a first recessed surface 225 which extends downwardly into and curves around the upper corner of the hitch pin cover structure 211 and the lower drawbar pin recess 222 is defined by a second recessed surface 226 which extends upwardly into and curves around the lower corner of the hitch pin cover structure 211. The first hitch ball pin recess 223 is defined by a third recessed surface 227 which extends forwardly into and curves around the rear corner of the hitch pin cover structure 211 and the second hitch ball pin recess 224, which is oriented between the first hitch ball pin recess 223 and the upper and lower drawbar pin recesses 221 and 222, is defined by a curved fourth recessed surface 228. When the assembly 201 is secured to the side beam 15a,the first and second recessed surfaces 225 and 226 fit against the ends 25 of the upwardly and downwardly located hitch pins 10a and the third or fourth recessed surface 227 or 228 extends proximate or adjacent to the end 25 of the hitch pin 10b, with circumferential portions of the upwardly and downwardly located hitch pins 10a oriented in proximity with the first and second recessed surfaces 225 and 226 and a circumferential portion of the hitch pin 10b oriented in proximity with the third recessed surface 227 or the fourth recessed surface 228.

The upper and lower drawbar pin recesses 221 and 222 and the first and second hitch ball pin recesses 223 and 224 extend inwardly into the hitch pin cover structure 211 from the inner face thereof, with a plurality of overlays or shrouds of the hitch pin cover structure 211 extending outwardly of and defining the depths of the drawbar pin recesses 221 and 222 and the hitch ball pin recesses 223 and 224. First and second overlays 229 and 230 extend outwardly of the upper and lower drawbar pin recesses 221 and 222 and third and fourth overlays 231 and 232 extend outwardly of the first and second hitch ball pin recesses 223 and 224. When the assembly 201 is secured to the side beam 15a, the ends 25 of the hitch pins 10a abut against or extend in closely spaced relation to the first and second overlays 229 and 230 and the end 25 of the hitch pin 10b abuts against or extends in closely spaced relation to the third or fourth overlay 231 or 232, and the hitch pins 10a and 10b cannot be angled, bent, jogged, or otherwise displaced and pulled around the hitch pin cover structure 211.

The drawbar 12 and hitch ball mount 14 of the hitch assembly 11 shown and described herein dictate vertical spacing of the hitch pins 10a such that when the hitch pin cover assembly 201 is secured to the side beam 15a, the upper and lower edges of the first and second recessed surfaces 225 and 226 are oriented in proximity to circumferential portions of the ends 25 of the upwardly and downwardly located hitch pins 10a as shown in FIG. 11. But it is understood that the hitch pin cover assembly 201 may be used with differently shaped and sized hitch assemblies, and the upper and lower drawbar pin recesses 221 and 222 may receive varyingly spaced apart hitch pins 10a that may be presented by such assemblies. For example, it is foreseen that the hitch pin cover assembly 201 may be used with a hitch assembly wherein the curved portions of the first and second recessed surfaces 225 and 226 are oriented in proximity to circumferential portions of the ends 25 of the upwardly and downwardly located hitch pins 10a.

The first or second shank leg 216 or 217 of the retaining clip 213 fits matingly within a shank receiving groove 240 formed in the hitch pin cover structure 211 as shown in FIG. 10. The shank receiving groove 240 is oriented rearward of the upper and lower drawbar pin recesses 221 and 222 and forward of the second hitch ball pin recesses 224 and extends downwardly into the inner face of the hitch pin cover structure 211, forming a relatively shallow neck 241 before expanding outwardly into the hitch pin cover structure 211 to form a relatively deep cavity 242. As shown in FIG. 11, a recess 243 is oriented between the second hitch ball pin recess 224 and the shank groove 240 and extends inwardly into the hitch pin cover structure 211 from the inner face thereof.

A lock receiving chamber 253 is formed in the hitch pin cover structure 211 and extends inward or rearward from the forward face thereof to an end wall (not shown) extending in close proximity to the shank receiving groove 240. A lock cap 252 is connected by a living hinge to a lock cap mounting ring 250 that is secured within a cap receiving recess 251 formed in the forward face of the hitch pin cover structure 211 around the lock receiving chamber 253. The lock cap 252 is selectively positionable to protect the lock barrel 214, positioned within the lock receiving chamber 253, from the ingress of debris or moisture, or to allow a key (not shown) to enter the lock barrel 214 for selective advancement of the lock 212 between the unlocked position and the locked position.

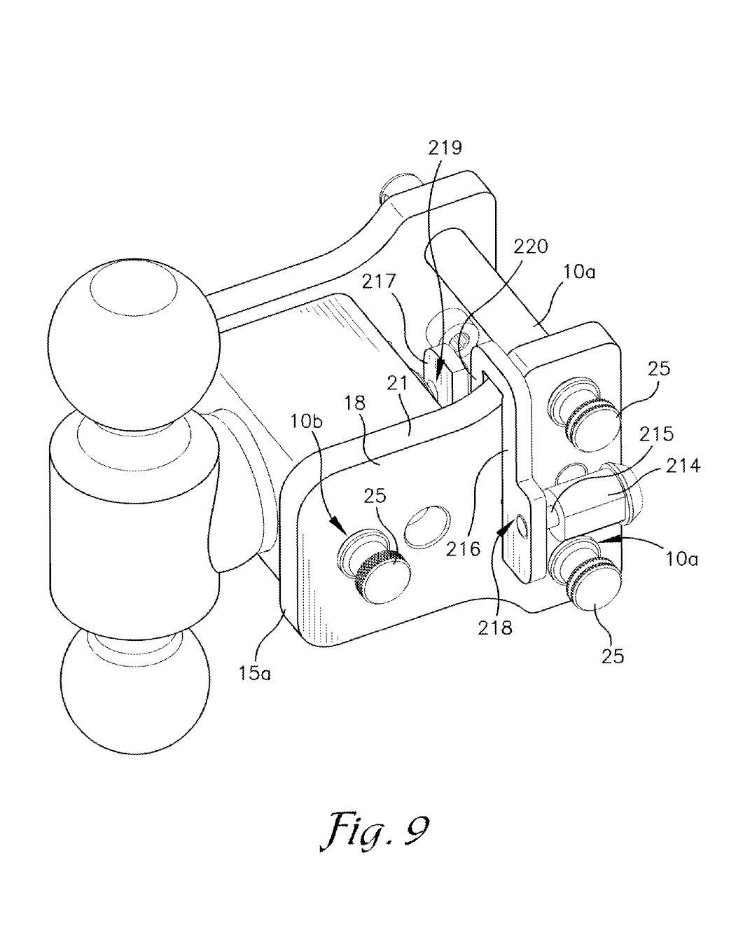

A bolt passageway 255 is formed centrally through the end wall connecting the lock receiving chamber 253 to the shank receiving groove 240. The lock barrel 214 fits within the lock receiving chamber 253 and the bolt 215 is extendable from the distal end of the lock barrel 214 to extend axially through the bolt passageway 255 and into the shank receiving groove 240. When the first or second shank leg 216 or 217 is positioned within the shank groove 240, the first or second bolt hole 218 or 219 of the respective shank leg 216 or 217 is coaxially aligned with the bolt passageway 255 and the bolt 215 is extendable therethrough. When the bolt 215 projects out of the lock barrel 214, the distal end thereof may extend in approximately the same plane as the rearwardly oriented face of the first or second shank leg 216 or 217 as shown in FIG. 9, but it is foreseen that the bolt 215 may extend further rearwardly into the hitch pin cover structure 211. For example, the bolt 215 may extend through an opening 256 formed between the shank groove 240 and the recess 243, and the bolt 215 may further extend through the recess 243 and into an opening 257 formed between the recess 243 and the second hitch ball pin recesses 224.

With reference to the orientation of the retaining clip 213 shown in FIG. 14, the first shank leg 216 extends upwardly from a foot 261 in which the first bolt hole 218 is formed and narrows in correspondence with the neck 241 of the shank groove 240. The first cross-arm 262 connects the first shank leg 216 with the hook leg 220, and the hook leg 220 extends downwardly from the first cross-arm 262. The second shank leg 217 extends downwardly from a foot 263 in which the second bolt hole 219 is formed and narrows in correspondence with the neck 241 of the shank groove 240, and a second cross-arm 264 connects the second shank leg 217 to the hook leg 220. The retaining clip 213 is thus generally S-shaped with the first slot or throat 265 formed between a sliding surface 266 of the first shank leg 216, a first sliding surface 267 of the hook leg 220, and a positioning surface 268 of the first cross-arm 262, and the second slot or throat 269 formed between a sliding surface 270 of the second shank leg 217, a second sliding surface 271 of the hook leg 220, and a positioning surface 272 of the second cross-arm 264. The first and second cross-arms 262 and 264 and the first and second slots 265 and 269 may differ in length and/or width, enabling use of the retaining clip 213 with differently sized side beams 15a as may be presented when the apparatus 5 is used with differently shaped and sized hitch assemblies.

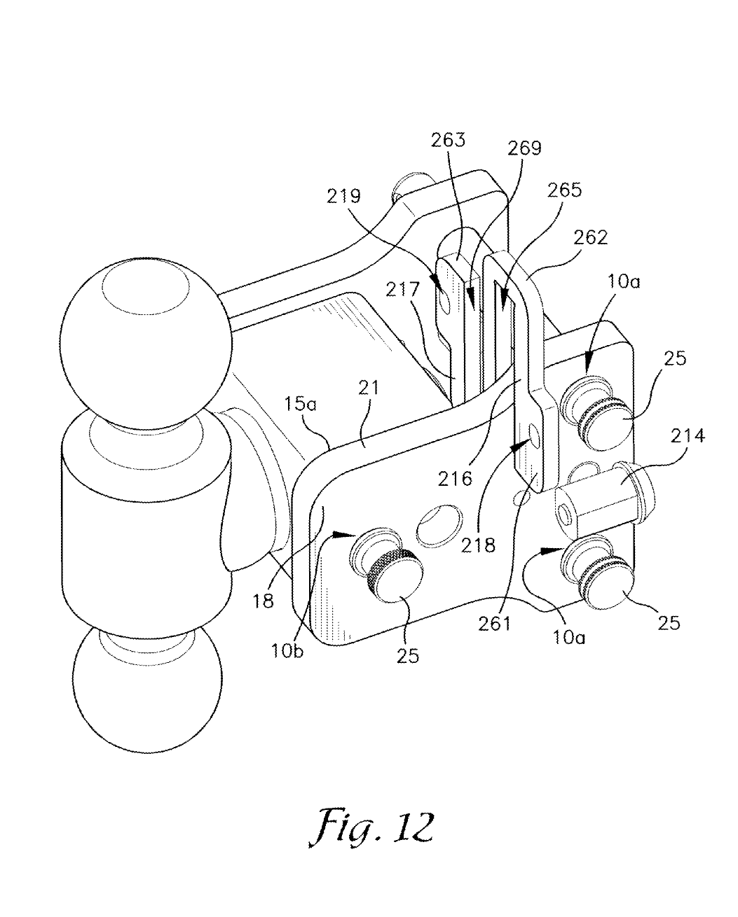

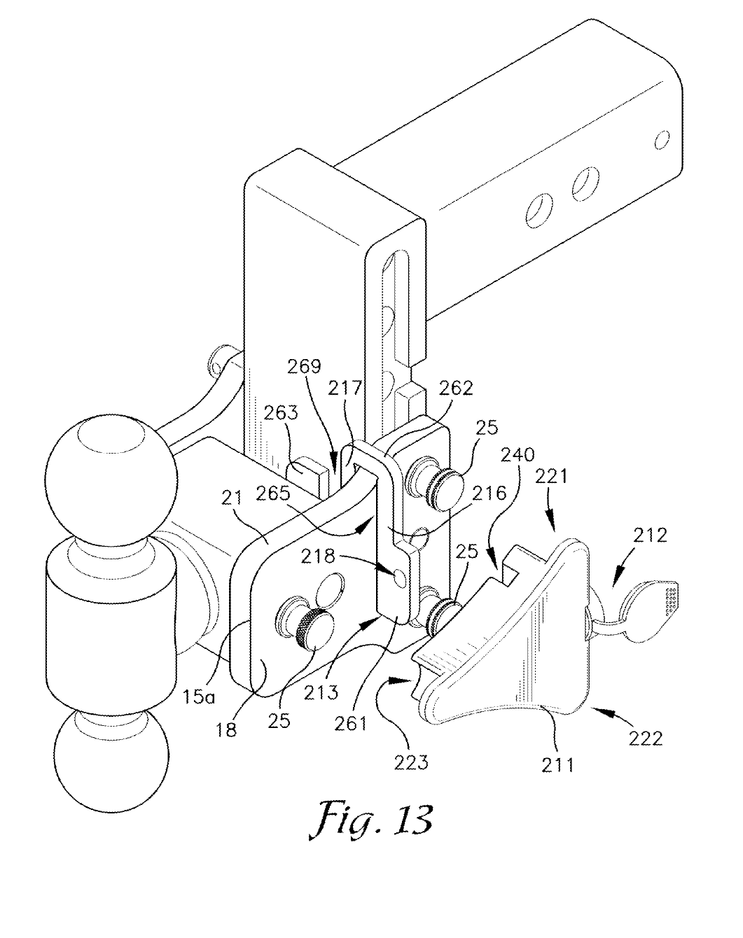

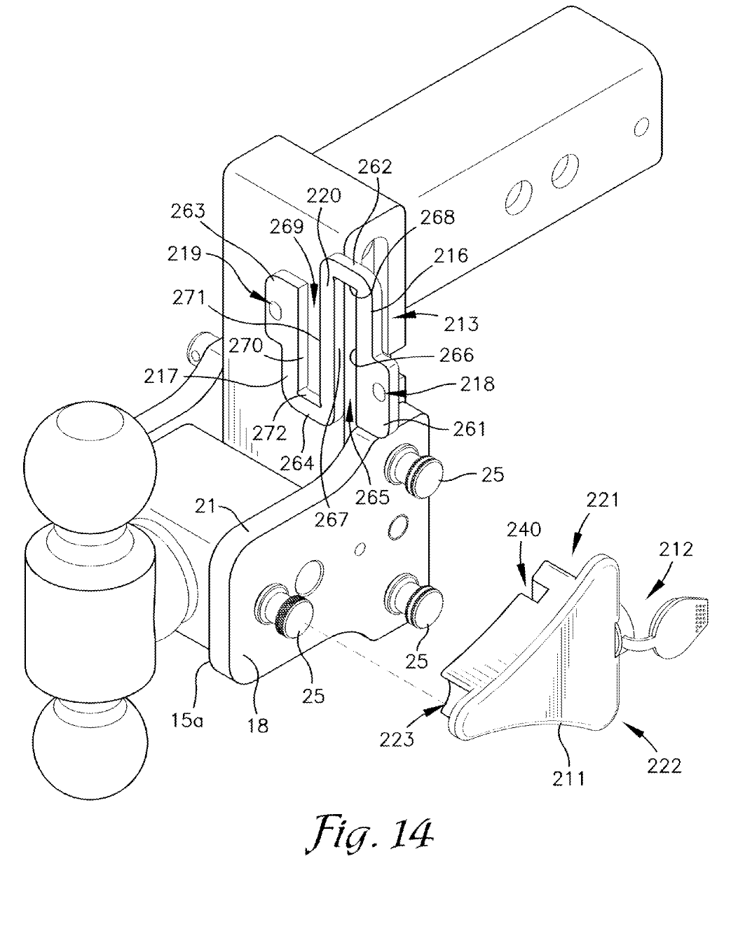

Referring now to FIGS. 12 and 13, the sliding surfaces 266 and 267 may be slid across and against the outer and inner faces 18 and 19 of the side beam 15a until the positioning surface 268 abuts against the upper face 21 of the side beam 15a. It is understood that the retaining clip 213 may be rotated 180 degrees from the orientation depicted in FIGS. 12-14, with the second shank leg 217 occupying the position of the first shank leg 216 and vice-versa. When the retaining clip 213 is so rotated, the first shank leg 216 extends downwardly from the foot 261 to the first cross-arm 262 and the second shank leg 217 extends upwardly from the foot 263 to the second cross-arm 264 such that the sliding surfaces 270 and 271 may be slid across and against the outer and inner faces 18 and 19 until the positioning surface 272 abuts against the upper face 21. The retaining clip 213 is thus matingly engageable with and can be said to “hook around” the side beam 15a.

Interaction of the lock 212 and the retaining clip 213 is now described with reference to FIGS. 9 and 12, in which FIG. 12 depicts the unlocked position of the lock 212 and FIG. 9 depicts the locked position of the lock 212. Advancement of the lock 212 to the unlocked position retracts the bolt 215 into the lock barrel 214 wherein the bolt 215 does not extend through the first or second bolt holes 218 or 219 or engage with the first or second shank legs 216 and 217 as the hitch pin cover structure 211 is moved inwardly or outwardly relative to the retaining clip 213. Retraction of the bolt 215 into the lock barrel 214 thus enables movement of the retaining clip 213 to a position wherein the first or second shank leg 216 or 217 fits matingly within the shank groove 240 and the first or second bolt hole 218 or 219 is coaxially aligned with the bolt passageway 255. With the retaining clip 213 so positioned, advancement of the lock 212 to the locked position extends the bolt 215 out of the lock barrel 214, extending the bolt 215 through the first or second bolt hole 218 or 219 and engaging the bolt 215 with the first or second shank leg 216 or 217 to fix the position of the retaining clip 213 relative to the hitch pin cover structure 211 and the lock 212. Because the lock 212 is advanceable to the locked position when either the first shank leg 216 or the second shank leg 217 fits matingly within the shank groove 240, the retaining clip 213 can hook onto side beams 15a of differing heights and sizes as may be presented when the hitch pin cover assembly 201 is used with differently shaped and sized hitch assemblies. When the retaining clip 213 is hooked over the side beam 15a and the lock 212 is advanced to the locked position, the hitch pin cover assembly 201 is secured to the side beam 15a and the hitch pin cover structure 211 cannot be pulled or otherwise outwardly displaced therefrom.

Operation of the locking pin cover assembly 201 is now described in accordance with an embodiment of the invention. The hitch assembly 11 is secured to the towing vehicle and the hitch ball mount 14 is adjusted to a desired height sufficient for connecting the trailer to the towing vehicle and is secured to the drawbar 12 by extending one or more hitch pins 10a through the drawbar 12 and the side beams 15a and 15b. The hitch ball assembly 16 is rotated such that a desired hitch ball 17 extends upwardly for engagement with coupler means of the trailer and the rotational position of the hitch ball assembly 16 is fixed by extending the hitch pin 10b through the holes or features formed in the side beams 15a and 15b and the aligned holes or features formed in the hitch ball assembly 16.

The lock 212 is advanced to the unlocked position with the bolt 215 retracted into the lock barrel 214, and the retaining clip 213 is pulled out of the shank groove 240 until the hitch pin cover structure 211 and the retaining clip 213 are spatially separated in positions such as those depicted in FIG. 14. The retaining clip 213 is moved downwardly toward the side beam 15a, with the sliding surfaces 266 and 267 advancing downwardly along the outer and inner faces 18 and 19 until the positioning surface 268 of the first cross-arm 262 abuts against the upper face 21 as shown in FIG. 13. Alternatively, the retaining clip 213 may be rotated 180 degrees before being moved downwardly toward the side beam 15a, with the sliding surfaces 270 and 271 advancing downwardly along the outer and inner faces 18 and 19 until thepositioning surface 272 of the second cross-arm 264 abuts against the upper face 21 of side beam 15a.

With the retaining clip 213 so positioned, the hitch pin cover structure 211 is moved toward the side beam 15a until the first or second shank leg 216 or 217 fits matingly within the shank groove 240 and, as shown in FIG. 8, the hitch pin cover structure 211 fits against the outer face 18 and extends in covering relationship over the ends 25 of the hitch pins 10a, 10b, with the ends 25 of the hitch pins 10a extending into the first and second drawbar pin recesses 221 and 222 and the end 25 of the hitch pin 10b extending into either the first or second hitch ball pin recess 223 or 224. The lock 212 is advanced from the unlocked position to the locked position and the bolt 215 projects out of the lock barrel 214 and through the first or second bolt hole 218 or 219 to fixedly secure the hitch pin cover assembly 201 to the side beam 15a. With the hitch pin cover assembly 201 secured to the side beam 15a, the first and second overlays 229 and 230 extend over the ends or heads 25 of the hitch pins 10a and one of the third or fourth overlays 231 or 232 extends over the end or head 25 of the hitch pin 10b.

The hitch pin cover assembly 201 is thus fixedly secured to the side beam 15a with the hitch pin covering structure 211 impeding removal of the hitch pins 10a, 10b from the hitch assembly 11. The first and second recessed surfaces 225 and 226 and a selective one of the third or fourth recessed surfaces 227 and 228 extending over the ends 25 of the hitch pins 10a, 10b cooperate to prevent upward, downward, rearward, or forward displacement of the hitch pin cover structure 211 from the side beam 15a, and the lock mechanism 212 and retaining clip 213 cooperate to prevent outward displacement of the hitch pin cover structure 211 from the side beam 15a.

To remove the hitch pin cover assembly 201 from the side beam 15a as may be desired to adjust the height of the hitch ball mount 14 and/or adjust the rotational position of the hitch ball assembly 16, the lock mechanism 212 is advanced from the locked position to the unlocked position to retract the bolt 215 into the lock barrel 214. The hitch pin cover structure 211 is pulled outwardly from the side beam 15a until the first or second shank leg 216 or 217 is free from the shank groove 240 and far enough outward to expose the hitch pins 10a and 10b to be removed from the hitch assembly 11 for adjustment of the hitch ball mount 14 and/or hitch ball assembly 16. Upon making the desired adjustments, the hitch pin cover assembly 201 is secured to the side beam 15a as described above to prevent removal of the hitch pins 10a and 10b from the hitch assembly 11.

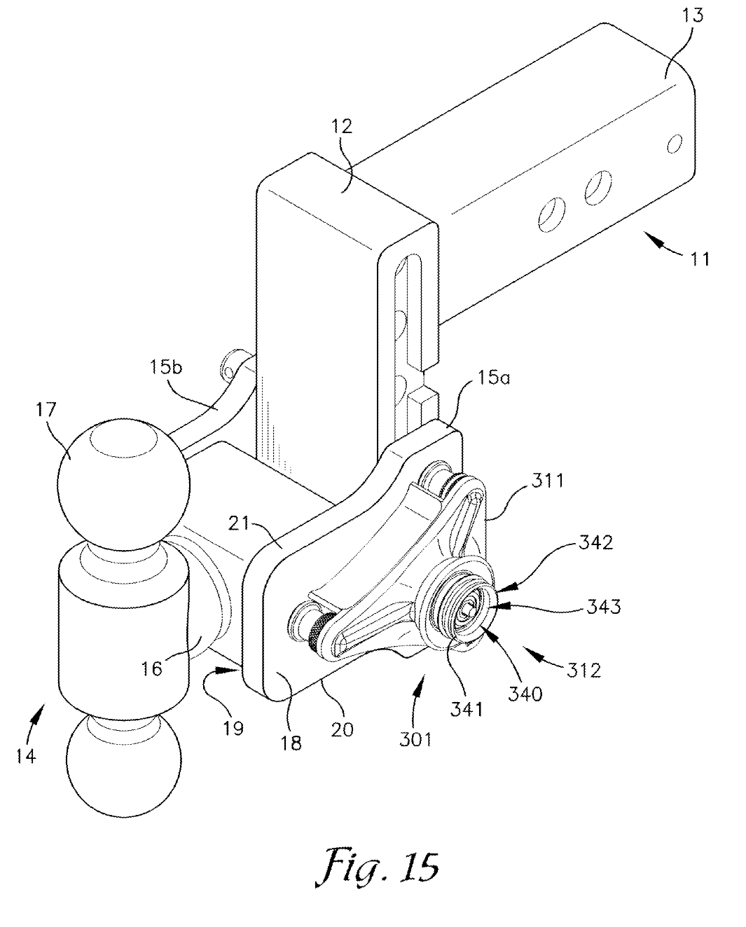

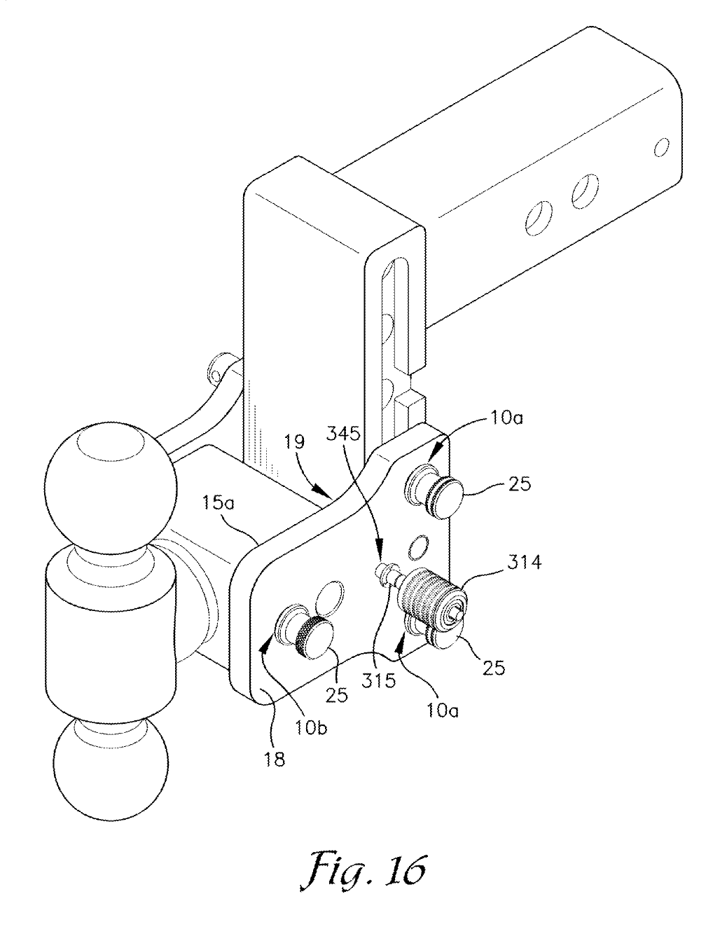

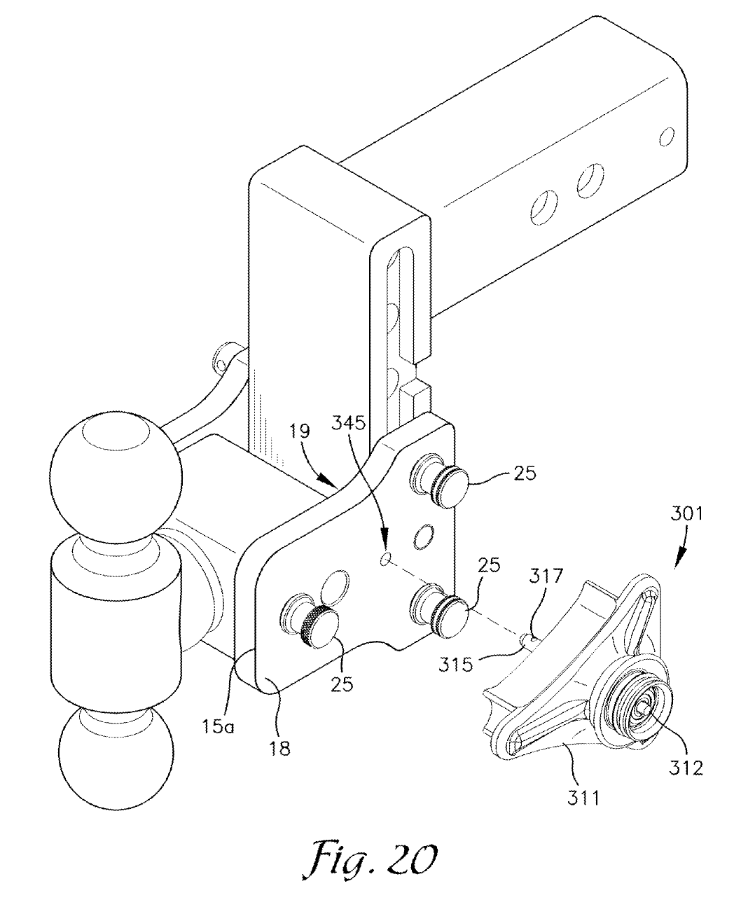

FIGS. 15-20 depict a second alternative embodiment of the locking, hitch pin cover assembly, which is denominated herein as hitch pin cover assembly 301. Like the assembly 201 described above, the assembly 301 includes a hitch pin cover structure 311 and a lock 312 and is particularly well-adapted for use with ball-type hitch assemblies that may be stowable, such as the hitch assembly disclosed in the ‘148 Patent. The hitch pin cover assembly 301 is generally used with the same hitch assembly 11 described above and is removably and lockably securable to the side beam 15a thereof in a similar manner.

The hitch pin cover structure 311 fits against the outer face 18 of the side beam 15a and is oriented outwardly of the ends 25 of the hitch pins 10a, 10b in covering relationship therewith for obstructing access to the hitch pins 10a, 10b and impeding removal of the hitch pins 10a, 10b from the hitch assembly 11. The lock 312 comprises a keyed lock barrel 314 that extends into the hitch pin cover structure 311 and a shaft 315 that extends axially from the lock barrel 314. The shaft 315 is equipped with one or more ball detents 317 that are operatively extendable out of or retractable into the lock barrel 314. The lock 312 is advanceable between a first or locked position wherein the ball detents 317 project radially out of the shaft 315 to fix the position of the hitch pin cover assembly 301 relative to the side beam 15a and a second or unlocked position wherein the ball detents 317 retract radially into the shaft 315 and the hitch pin cover assembly 301 is inwardly and outwardly movable relative to the side beam 15a. The lock 312 of the embodiment shown may be of a type using a key inserted into the lock barrel 314 for rotatably advancing the lock 312 between the locked and unlocked positions.

A plurality of recesses are formed in the hitch pin cover structure 311 for receiving the heads or ends 25 of the hitch pins 10a, 10b, including first and second drawbar pin recesses 321 and 322 and first and second hitch ball pin recesses 323 and 324. The end 25 of the upwardly located hitch pin 10a is extendable into the first drawbar pin recess 321, which may also be referred to as the upper drawbar pin recess 321, and the end 25 of the downwardly located hitch pin 10a is extendable into the second drawbar pin recess 322, which may also be referred to as the lower drawbar pin recess 322. The end 25 of the hitch pin 10b is extendable into a selective one of the first and second hitch ball pin recesses 323 and 324 depending on the rotational position of the hitch ball assembly 16. When the hitch pin 10b fixes the hitch ball assembly 16 in the rotational position shown in FIG. 15, for example, the end 25 thereof extends into the first hitch ball pin recess 323. It is understood that the hitch pin 10b may fix the hitch ball assembly 16 in a rotational position wherein the end 25 thereof extends into the second hitch ball pin recess 324.

In the embodiment shown in FIGS. 15-20, the hitch pin cover structure 311 is a generally triangular structure, but it is foreseen that the hitch pin cover structure 311 may comprise other geometries, such as polygonal or elliptical, and it is further foreseen that the hitch pin cover structure 311 may be a shell-like or substantially hollow structure having one or more interior spaces formed therein.

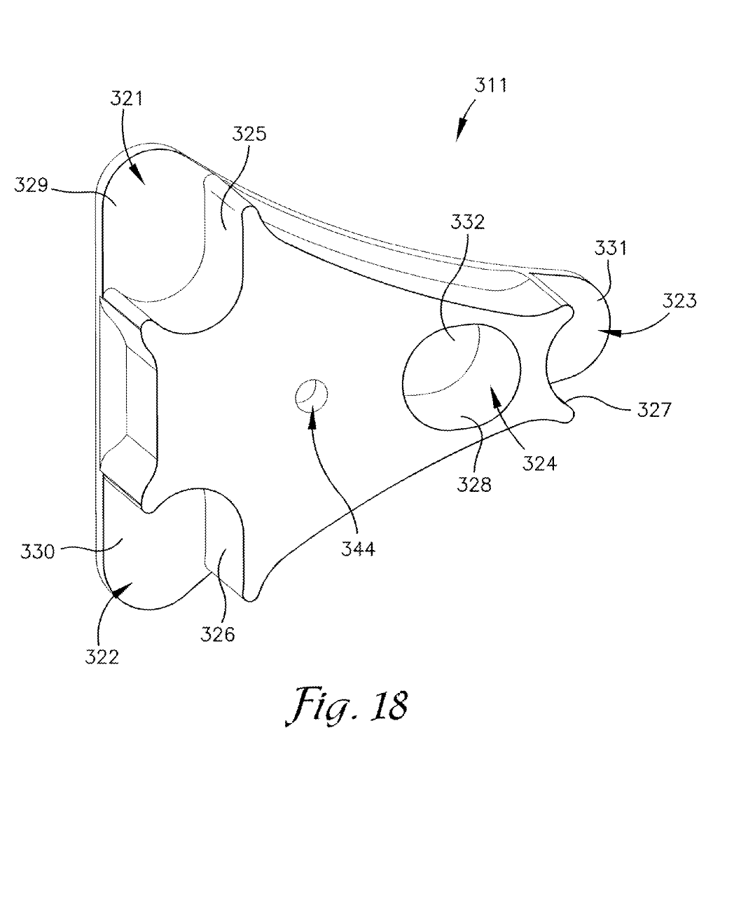

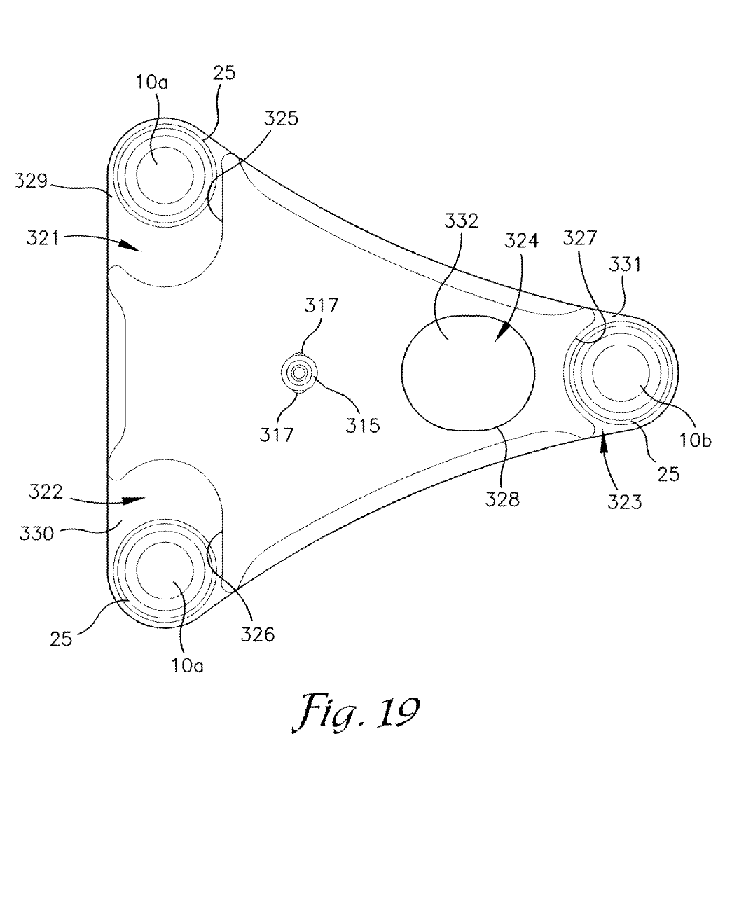

Referring now to FIGS. 18 and 19, the upper drawbar pin recess 321 is defined by a first recessed surface 325 which extends downwardly into and curves around the upper corner of the hitch pin cover structure 311 and the lower drawbar pin recess 322 is defined by a second recessed surface 326 which extends upwardly into and curves around the lower corner of the hitch pin cover structure 311. The first hitch ball pin recess 323 is defined by a third recessed surface 327 which extends forwardly into and curves around the rear corner of the hitch pin cover structure 311 and the second hitch ball pin recess 324, which is oriented between the first hitch ball pin recess 323 and the upper and lower drawbar pin recesses 321 and 322, is defined by a circular or ovate shaped fourth recessed surface 328. When the assembly 301 is secured to the side beam 15a, the first and second recessed surfaces 325 and 326 abut against or extend in closely spaced relationship to the ends 25 of the upwardly and downwardly located hitch pins 10a and the third or fourth recessed surface 327 or 328 abuts against the end 25 of the hitch pin 10b, with circumferential portions of the upwardly and downwardly located hitch pins 10a oriented in proximity with the first and second recessed surfaces 325 and 326 and a circumferential portion of the hitch pin 10b oriented in proximity with the third recessed surface 327 or the fourth recessed surface 328.

The upper and lower drawbar pin recesses 321 and 322 and the first and second hitch ball pin recesses 323 and 324 extend inwardly into the hitch pin cover structure 311 from the inner face thereof, with a plurality of overlays or shrouds of the hitch pin cover structure 311 extending outwardly over and defining the depths of the drawbar pin recesses 321 and 322 and the hitch ball pin recesses 323 and 324. First and second overlays 329 and 330 extend outwardly over the upper and lower drawbar pin recesses 321 and 322 and third and fourth overlays 331 and 332 extend outwardly over the first and second hitch ball pin recesses 323 and 324. When the assembly 301 is secured to the side beam 15a, the ends 25 of the hitch pins 10a abut against or extend in closely spaced relation to the first and second overlays 329 and 330 and the end 25 of the hitch pin 10b abuts against or extends in closely spaced relation to the third or fourth overlay 331 or 332, and the hitch pins 10a and 10b cannot be angled, bent, jogged, or otherwise displaced and pulled around the hitch pin cover structure 311.

The drawbar 12 and hitch ball mount 14 of the hitch assembly 11 shown and described herein dictate vertical spacing of the hitch pins 10a such that when the hitch pin cover assembly 301 is secured to the side beam 15a, the upper and lower edges of the first and second recessed surfaces 325 and 326 are oriented in proximity to circumferential portions of the ends 25 of the upwardly and downwardly located hitch pins 10a as shown in FIG. 19. But it is understood that the hitch pin cover assembly 301 may be used with differently shaped and sized hitch assemblies, and the upper and lower drawbar pin recesses 321 and 322 may receive varyingly spaced apart hitch pins 10a that may be presented by such assemblies. For example, it is foreseen that the hitch pin cover assembly 301 may be used with a hitch assembly wherein the curved portions of the first and second recessed surfaces 325 and 326 are oriented in proximity to circumferential portions of the ends 25 of the upwardly and downwardly located hitch pins 10a.

Referring now to FIG. 15, the lock 312 is secured within a lock receiver 340 formed centrally in the outer face of the hitch pin cover structure 311. A lock cap (not shown) may be securable to a ridged ring structure 341 surrounding the lock receiver 340 to selectively cover the lock barrel 314 of the lock 312 secured within a lock receiving chamber 342 of the lock receiver 340. The lock cap is selectively positionable to protect the lock barrel 314 from ingress of debris or moisture or to allow a key (not shown) to enter the lock barrel 314 for selective advancement of the lock 312 between the unlocked position and the locked position. The lock receiving chamber 342 extends inwardly to an offset surface 343 with a passageway 344 formed centrally therein.

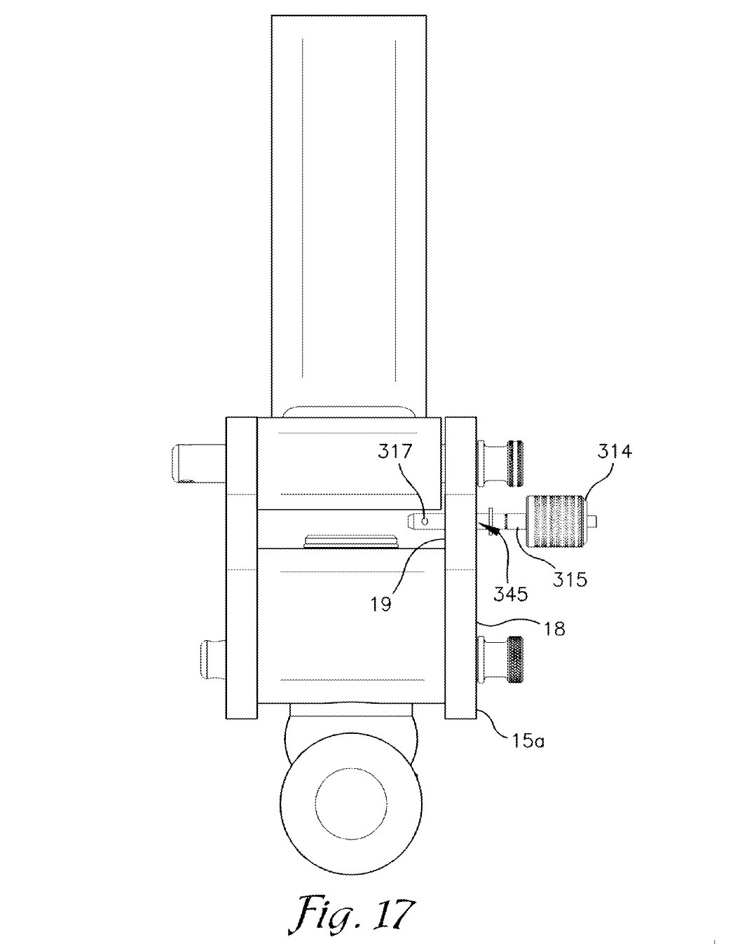

The lock barrel 314 fits within the chamber 342 and the shaft 315 extends inwardly from the lock barrel 314 and through the passageway 344. The shaft 315 is extendable through a shaft hole 345 formed in the side beam 15a to position the ball detents 317 just inward from the inner surface of the side beam 15a. When the hitch pin cover structure 311 fits against the outer face 18 of the side beam 15a and the ball detents 317 are positioned as shown in FIG. 17, advancement of the lock mechanism 312 to the locked position advances the ball detents 317 out of the shaft 315 with the ball detents 317 extending outward and in closely spaced relation relative to the inner face 19 of the side beam 15a. When the ball detents 317 are so engaged, the assembly 301 is secured to the side beam 15a and the hitch pin cover structure 311 cannot be pulled or otherwise outwardly displaced therefrom without applying sufficient force to damage the lock 312.

Although the lock 312 only includes one set of ball detents 317 in the embodiment of the assembly 301 shown and described herein, it is foreseen that the lock 312 may include a plurality of sets of ball detents 317 which may be extendable in a plurality of planes extending radially from different locations on the axis of the shaft 315, enabling use of the assembly 301 with side beams 15a of varying thicknesses as may be presented when the hitch pin cover assembly 301 is used with differently shaped and sized hitch assemblies. It is further foreseen that the shaft 315 may include biasing means and other mechanisms formed therein to project or retract the ball detents 317 out of or into the shaft 315. For example, the lock 312 may be self-locking, with one or more springs embedded in the shaft 315 which bias the ball detents 317 to project radially outward as the shaft 315 passes through the shaft hole 345.

Operation of the locking pin cover assembly 301 is now described in accordance with an embodiment of the invention. The hitch assembly 11 is secured to the towing vehicle and the hitch ball mount 14 is adjusted to a desired height sufficient for connecting the trailer to the towing vehicle and is secured to the drawbar 12 by extending one or more hitch pins 10a through the drawbar 12 and the side beams 15a and 15b. The hitch ball assembly 16 is rotated such that a desired hitch ball 17 extends upwardly for engagement with coupler means of the trailer and the rotational position of the hitch ball assembly 16 is fixed by extending the hitch pin 10b through the holes or features formed in the side beams 15a and 15b and the aligned holes or features formed in the hitch ball assembly 16.

The lock mechanism 312 is advanced to the unlocked position with the ball detents 317 retracted within the shaft 315 and the hitch pin cover assembly 301 is moved toward the hitch assembly 11 until the shaft 315 passes through the shaft hole 345 and the hitch pin cover structure 311 fits against the outer face 18 of the side beam 15a and extends in covering relationship over the ends 25 of the hitch pins 10a, 10b, with the ends 25 of the hitch pins 10a extending into the first and second drawbar pin recesses 321 and 322 and the end 25 of the hitch pin 10b extending into either the first or second hitch ball pin recess 323 or 324. The lock 312 is advanceable from the unlocked position to the locked position advancing the ball detents 317 out of the shaft 315 and into engagement with the inner face 19 of the side beam 15a.

The assembly 301 is thus secured to the side beam 15a with the hitch pin cover structure 311 impeding removal of the hitch pins 10a, 10b from the hitch assembly 11. The first and second recessed surfaces 325 and 326 and a selective one of the third or fourth recessed surfaces 327 or 328 abutting against the ends 25 of the hitch pins 10a, 10b cooperate to prevent upward, downward, rearward, or forward displacement of the hitch pin cover structure 311 from the side beam 15a, and the ball detents 317 and inner face 19 of the side beam 15a cooperate to prevent outward displacement of the hitch pin cover structure 311 from the side beam 15a.

To remove the hitch pin cover assembly 301 from the side beam 15a as may be desired to adjust the height of the hitch ball mount 14 and/or adjust the rotational position of the hitch ball assembly 16, the lock mechanism 312 is adjusted from the locked position to the unlocked position to retract the ball detents 317 into the shaft 315. The hitch pin cover assembly 301 is pulled outwardly from the side beam 15a, exposing the hitch pins 10a and 10b to be removed from the hitch assembly for adjustment of the hitch ball mount 14 and/or hitch ball assembly 16. Upon making the desired adjustments, the assembly 301 is secured to the side beam 15a as described above to prevent removal of the hitch pins 10a and 10b from the hitch assembly 11.

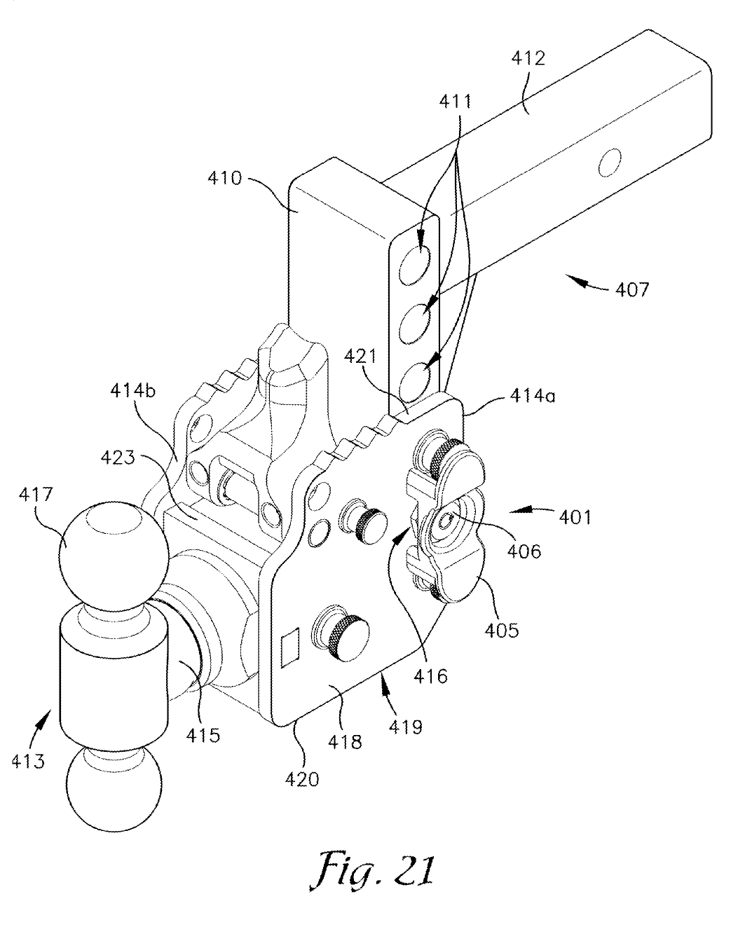

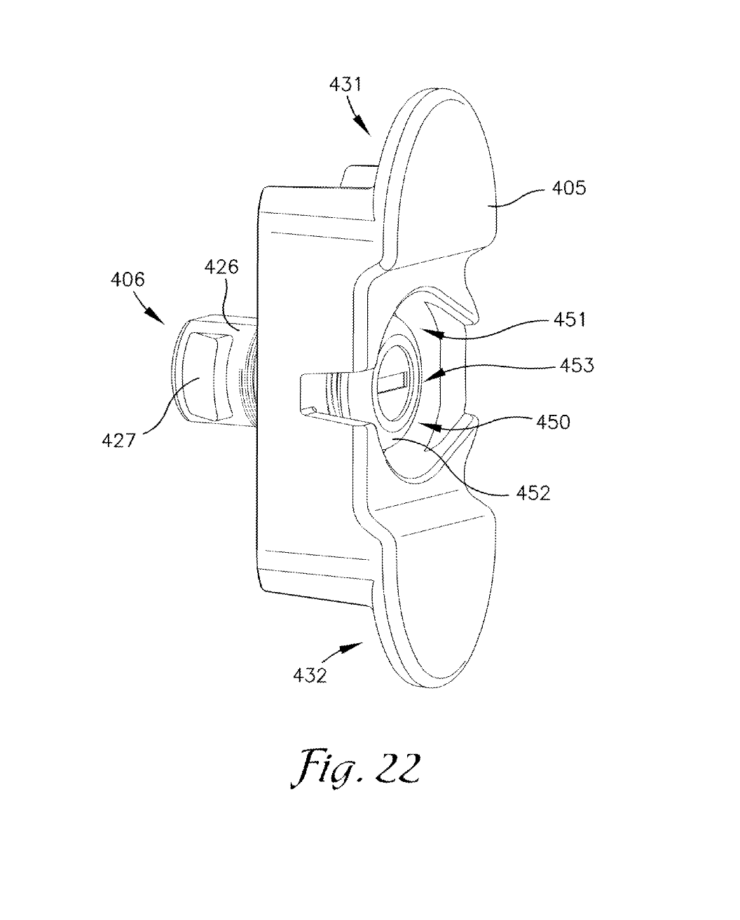

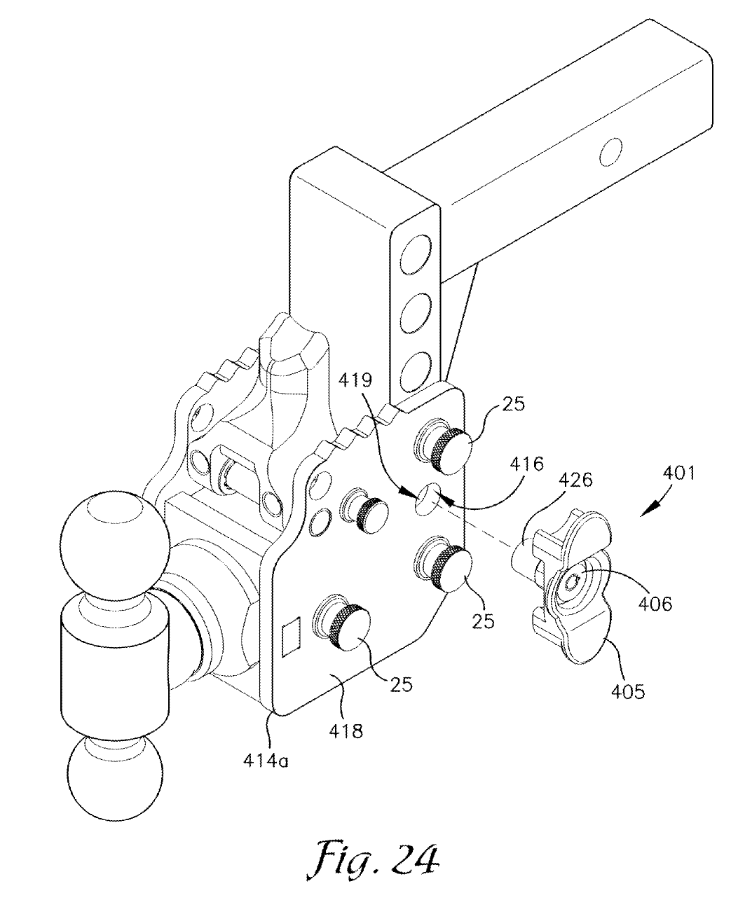

FIGS. 21-24 depict a third alternative embodiment of the locking, hitch pin cover assembly, which is denominated herein as hitch pin cover assembly 401. Like the assembly 301 described above, the assembly 401 includes a hitch pin cover structure 405 and a lock mechanism 406 and prevents theft of hitch pins 10a and 10b used with a hitch assembly for connecting a trailer to a towing vehicle.

The assembly 401 is particularly well-adapted for use with pintle-type hitch assemblies that may be stowable, such as the hitch assembly disclosed in U.S. Patent No. 6,789,815 assigned to B&W Custom Truck Beds, Inc. of Humboldt, Kansas, and is also adapted for use with other variations of hitch assemblies suitable for connecting a trailer to a towing vehicle, including hitch assemblies having stacked receivers such as the hitch assembly disclosed in U.S. Patent No. 12,097,732 assigned to Gen-Y Creations, LLC of Nappanee, IN. As shown in FIG. 21, the hitch assembly 407 includes a drawbar or pin block 410 having a plurality of serially disposed pin receiving holes 411 or other mounting features extending transversely therethrough. The drawbar 410 is connected to a shank 412 for securing the drawbar 410 to a square tube receiver of a towing vehicle. A hitch ball mount assembly 413, comprising a pair of side beams 414a and 414b, a hitch ball support block 423, and a hitch ball assembly 415 is adjustably securable to the drawbar 410 by one or more hitch pins 10a which extend through holes or features formed in the side beams 414a and 414b and selected ones of the pin receiving holes 411 formed in the drawbar 410. The holes or features formed in the side beams 414a and 414b are alignable with the holes 411 formed in the drawbar 410. A lock hole 416 is formed in the side beam 414a between the holes through which the hitch pins 10a extend. The lock hole 416 may have a smaller diameter than the holes 411 in the draw bar 410 and is alignable in slightly off-centered relation with a selected one of the holes 411, with a portion of the side beam 414a oriented in overlapping relationship with and outwardly of a portion of the hole 411 with which the lock hole 416 is aligned.

The hitch ball support block 423 is fixedly secured to the side beams 414a and 414b. The hitch ball assembly 415 is supported by the hitch ball support block 423 and includes multiple outwardly projecting hitch balls 417, one or more of which may foreseeably be replaced with a pintle shaft or hitch (not shown). The rotational position of the hitch ball assembly 415 is fixed by a hitch pin 10b which extends selectively through holes or features formed in the side beams 414a and 414b and a pair of holes or features formed in the hitch ball assembly 415, the holes or features formed in the hitch ball assembly 415 being alignable with the holes or features formed in the side beams 414a and 414b as the rotational position of the hitch ball assembly 415 is adjusted. The hitch pin cover assembly 401 shown and described herein are discussed as being engageable with or secured to the side beam 414a and an outer face 418, inner face 419, lower face 420, and upper face 421 thereof, but it is understood that the hitch pin cover assembly 401 may alternatively be engaged with or secured to the side beam 414b and like faces and edges thereof.

The hitch pin cover structure 405 fits against the outer face 418 of the side beam 414a and is oriented outwardly of the ends 25 of the hitch pins 10a in covering relationship therewith for obstructing access to the hitch pins 10a and impeding removal of the hitch pins 10a from the hitch assembly 407. The lock 406 comprises a keyed lock barrel 426 that extends axially through the hitch pin cover structure 405 and a bolt or latch 427 that is operatively extendable out of or retractable into the lock barrel 426. The lock 406 is advanceable between a first or locked position wherein the latch 427 projects laterally out of the lock barrel 426 to fix the position of the hitch pin cover assembly 401 relative to the side beam 414a and a second or unlocked position wherein the latch 427 retracts laterally into the lock barrel 426 and the hitch pin cover assembly 401 is inwardly and outwardly movable relative to the side beam 414a.

First and second recesses 431 and 432 are formed in the hitch pin cover structure 405 for receiving the heads or ends 25 of the hitch pins 10a. The end 25 of the upwardly located hitch pin 10a is extendable into the first recess 431, which may also be referred to as the upper recess 431, and the end 25 of the downwardly located hitch pin 10a is extendable into the second recess 432, which may also be referred to as the lower recess 432. In the embodiment shown in FIGS. 21-24, the hitch pin cover structure 405 is a generally oblong structure, but it is foreseen that the hitch pin cover structure 405 may comprise other geometries, such as polygonal or elliptical, and it is further foreseen that the hitch pin cover structure 405 may be a shell-like or substantially hollow structure having one or more interior spaces formed therein.

Referring now to FIG. 23, the upper recess 431 is defined by a first recessed surface 433 which extends downwardly into and curves around the upper edge of the hitch pin cover structure 405 and the lower recess 432 is defined by a second recessed surface 434 which extends upwardly into and curves around the lower edge of the hitch pin cover structure 405. When the assembly 401 is secured to the side beam 414a, the first and second recessed surfaces 433 and 434 abut against or extend in closely spaced relation to the ends 25 of the upwardly and downwardly located hitch pins 10a, with circumferential portions of the upwardly and downwardly located hitch pins 10a extending in proximity with the first and second recessed surfaces 433 and 434. The upper and lower recesses 431 and 432 extend inwardly into the hitch pin cover structure 405 from the inner face thereof, with upper and lower overlays or shrouds 435 and 436 extending outwardly of and defining the depths of the upper and lower recesses 431 and 432. When the assembly 401 is secured to the side beam 414a, the ends 25 of the hitch pins 10a abut against or extend in closely spaced relation with the first and second overlays 435 and 436, and the hitch pins 10a cannot be angled, bent, jogged, or otherwise displaced and pulled around the hitch pin cover structure 405.

The drawbar 410 and hitch ball mount 413 of the hitch assembly 407 shown and described herein dictate vertical spacing of the hitch pins 10a such that when the assembly 401 is secured to the side beam 15a, curved portions of the first and second recessed surfaces 433 and 434 are oriented in proximity to circumferential portions of the ends 25 of the upwardly and downwardly located hitch pins 10a. But it is understood that the hitch pin cover assembly 401 may be used with differently shaped and sized hitch assemblies, and the upper and lower recesses 431 and 432 may receive varyingly spaced apart hitch pins 10a that may be presented by such assemblies.

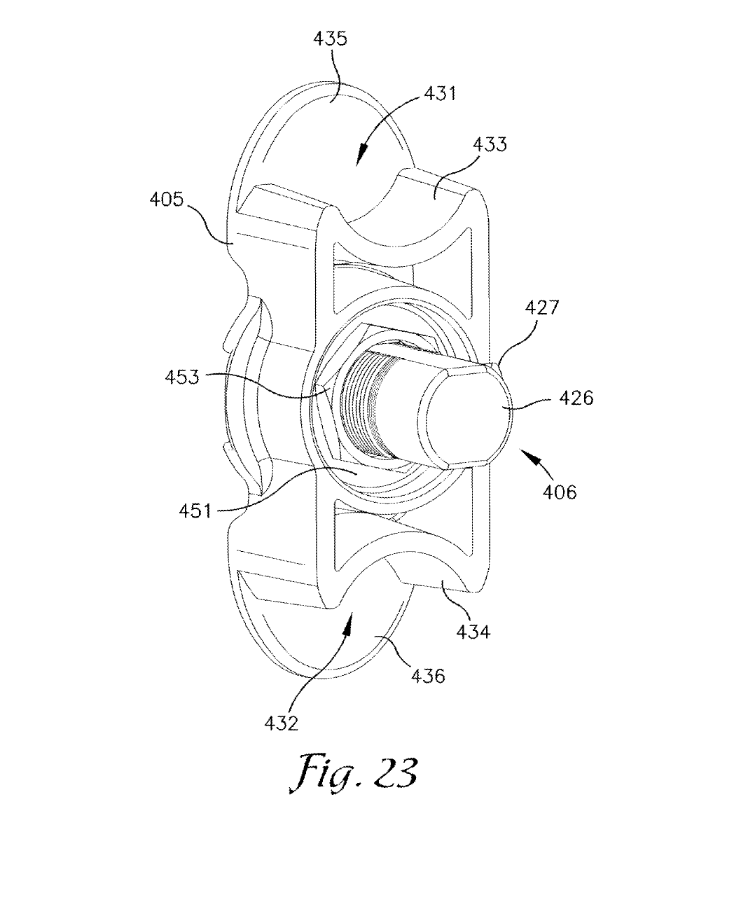

Referring to FIG. 22, a lock receiving opening 450 is formed in and extends through the hitch pin cover structure 405 from an outer face to an inner side thereof. A shoulder 451 projects inward from a sidewall forming the lock receiving opening 450 against which the underside of a head 452 of the lock 406 abuts. A nut 453 may be threaded onto a threaded section of the lock barrel 426 and up against the underside of the shoulder 451 to secure the lock 406 within the lock receiving opening 450 and against the shoulder 451. A lock cap (not shown) that may be connected or secured to the hitch pin cover structure 405 to be selectively positioned in covering relationship over the inlet to the lock barrel 426 of the lock mechanism 406. The lock cap is selectively positionable to protect the lock barrel 426 from the ingress of debris or moisture or to allow a key (not shown) to enter the lock barrel 426 for selective advancement of the lock mechanism 406 between the unlocked position and the locked position. The lock barrel 426 passes through the lock receiving opening 450 and past the shoulder 451 and is extendable through the lock hole 416 in the side beam 414a to position the latch 427 within the hole 411 of the drawbar 410 with which the lock hole 416 is aligned.

When the hitch pin cover structure 405 fits against the outer face 418 of the side beam 414a and the lock barrel 426 extends through the lock hole 416, advancement of the lock mechanism 406 to the locked position advances the bolt 427 out of the lock barrel 426 such that the bolt 427 engages the portion of the inner face 419 of the side beam 414a extending in overlapping relationship with a portion of the hole 411. When the bolt 427 is so engaged, the assembly 401 is secured to the side beam 414a and the hitch pin cover structure 405 cannot be pulled out otherwise outwardly displaced therefrom.

Although the lock 406 comprises only one bolt 427 in the embodiment of the assembly 401 shown and described herein, it is foreseen that the lock 406 may comprise a plurality of bolts 427 which may be projectable in a plurality of planes extending laterally from different locations on the axis of the lock barrel 426, enabling use of the assembly 401 with side beams 414a of varying thicknesses as may be presented when the assembly 401 is used with differently shaped and sized hitch assemblies. It is further foreseen that the lock barrel 426 may include biasing means and other mechanisms formed therein to extend or retract the bolt 427 out of or into the lock barrel 426. For example, the lock mechanism 406 may be self-locking, with one or more springs embedded in the lock barrel 426 which bias the bolt 427 to project laterally outward as the bolt 427 passes through the lock hole 416 and into the hole 411.

Operation of the locking pin cover assembly 401 is now described in accordance with an embodiment of the invention. The hitch assembly 407 is secured to the towing vehicle and the hitch ball mounting assembly 413 is adjusted to a desired height sufficient for connecting the trailer to the towing vehicle and is secured to the drawbar 410 by extending hitch pins 10a through the side beams 414a and 414b and through the holes 411 of the drawbar 410. The hitch ball assembly 415 is rotated such that a desired hitch ball 417 extends upwardly for engagement with coupler means of the trailer and the rotational position of the hitch ball assembly 415 is fixed by extending the hitch pin 10b through the holes or features formed in the side beams 414a and 414b and the aligned holes or features formed in the hitch ball assembly 415.

The lock 406 is advanced to the unlocked position with the latch 427 retracted within the lock barrel 426 and the assembly 401 is moved toward hitch assembly 407 until the lock barrel 426 passes through the lock hole 416 and the hitch pin cover structure 405 fits against the outer face 418 of the side beam 414a and extends in covering relationship over the ends 25 of the hitch pins 10a, with the ends 25 of the hitch pins 10a extending into the upper and lower recesses 431 and 432. The lock 406 is advanced from the unlocked position to the locked position and the latch 427 projects out of the lock barrel 426 to engage with the inner face 419 of the side beam 414a. The hitch pin cover assembly 401 is thus secured to the side beam 414a with the hitch pin cover structure 405 impeding removal of the hitch pins 10a from the hitch assembly 407. The first and second recessed surfaces 433 and 434 abut against sides of the heads 25 of the hitch pins 10a preventing upward, downward, rearward, or forward displacement of the hitch pin cover structure 405. The latch 427 and inner face 419 of the side beam 414a cooperate to prevent outward displacement of the hitch pin cover structure 405 from the outer face 418 of the side beam 414a.

To remove the assembly 401 from the side beam 414a as may be desired to adjust the hitch of the hitch ball mounting assembly 413, the lock 406 is advanced from the locked position to the unlocked position to retract the latch 427 into the lock barrel 426. The hitch pin cover assembly 401 is pulled outwardly from the side beam 414a,exposing the hitch pins 10a to be removed from the hitch assembly 407 for adjustment of the hitch ball mounting assembly 413. Upon making the desired adjustments, the hitch pin cover assembly 401 is secured to the side beam 414a as described above to prevent removal of the hitch pins 10a from the hitch assembly 407.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed is:

1. A pin cover assembly for preventing theft of hitch pins used with a hitch assembly, the pin cover assembly comprising:
a hitch pin cover structure extendable in covering relationship over ends of the hitch pins;
a lock extending into the hitch pin cover structure, the lock advanceable between a locked position and an unlocked position;
in the locked position, the hitch pin cover structure fixedly secured to the hitch assembly to obstruct access to the hitch pins; and
in the unlocked position, the hitch pin cover structure removable from the hitch assembly to expose the hitch pins.

2. The pin cover assembly as in claim 1, wherein the lock comprises a lock barrel and a latch, the lock barrel extendable through a hole formed in a side beam of the hitch assembly, the latch projectable out of and retractable into the lock barrel.

3. The pin cover assembly as in claim 1, wherein the lock comprises a shaft including a ball detent, the ball detent projectable out of and retractable into the shaft.

4. The pin cover assembly as in claim 1, wherein the lock is extendable through a hole formed in a side member of the hitch assembly, the lock engaging an inner surface of the side member upon advancement of the lock to the locked position.

5. The pin cover assembly as in claim 1, wherein the hitch pin cover structure comprises first and second covering shells, the first and second covering shells defining respective interior spaces sized to receive the ends of the hitch pins.

6. The pin cover assembly as in claim 1, wherein the hitch pin cover structure includes a plurality of pin recesses configured to receive the ends of the hitch pins, each pin recess defined by a recessed surface and an overlay.

7. The pin cover assembly as in claim 1, wherein the hitch pin cover structure includes a lock receptacle for receiving a lock barrel of the lock.

8. The pin cover assembly as in claim 1, further comprising a retaining clip selectively engageable with a side member of the hitch assembly and having a lock receiving feature engaged by the lock upon advancement of the lock to the locked position, engagement of the lock and the lock receiving feature fixedly securing the hitch pin cover structure to the retaining clip.

9. The pin cover assembly as in claim 8, wherein advancement of the lock to the unlocked position disengages the lock from the lock receiving feature of the retaining clip, allowing separation of the hitch pin cover structure from the retaining clip.

10. A locking cover assembly for a hitch assembly having one or more hitch pins extending through a side beam thereof, the locking cover assembly comprising:
a pin cover configured to abut against an outer face of the side beam;
a retaining clip engageable with the side beam and extendable into the pin cover; and
a lock mounted to and extending within the pin cover, the lock advanceable between a locked position, wherein the lock is engaged with the retaining clip to fixedly secure the retaining clip and the pin cover to the side beam such that the pin cover extends in covering relationship over ends of the hitch pins to obstruct removal of the hitch pins from the hitch assembly, and an unlocked position, wherein the lock is disengaged from the retaining clip such that the retaining clip and the pin cover are removable from the side beam.

11. The locking cover assembly as in claim 10, wherein the retaining clip comprises a shank leg and a hook leg, the shank leg and the hook leg spaced apart from each other and connected by a cross-arm.

12. The locking cover assembly as in claim 11, wherein the retaining clip is configured to hook around a lower face of the side beam such that when the lock is in the locked position, the shank leg fits snugly against the outer face of the side beam and the hook leg fits snugly against an inner face of the side beam.

13. The locking cover assembly as in claim 11, wherein the shank leg is slidable into and out of an opening formed in the pin cover.

14. The locking cover assembly as in claim 10, wherein the retaining clip includes a slot through which a bolt of the lock extends, the slot permitting limited sliding movement of the retaining clip relative to the pin cover when the lock is in the unlocked position.

15. The locking cover assembly as in claim 10, wherein the retaining clip includes first and second shank legs and a hook leg connecting the first shank leg to the second shank leg, each of the first and second shank legs spaced apart from the hook leg to define a first groove extending between the first shank leg and the hook leg and a second groove extending between the second shank leg and the hook leg.

16. The locking cover assembly as in claim 15, wherein each of the first and second shank legs includes a bolt hole for receiving a bolt of the lock upon advancement of the lock to the locked position.

17. A locking cover assembly for a hitch assembly having one or more hitch pins, the locking cover assembly comprising:
a pin cover configured to abut against the hitch assembly and to extend in covering relationship over ends of the hitch pins; and
locking means selectively securing the pin cover to the hitch assembly, wherein the locking means is advanceable between a locked position to fixedly secure the pin cover to the hitch assembly, thereby preventing removal of the hitch pins, and an unlocked position to remove the pin cover from the hitch assembly, thereby allowing removal of the hitch pins.

18. The locking cover assembly as in claim 17, further comprising retaining means for engaging with the hitch assembly to resist separation of the pin cover therefrom, the retaining means cooperable with the locking means.
